(19) United States
(12) Patent Application Publication
(10) Pub. No.: US 2010/0319345 A1
(43) Pub. Date: Dec. 23, 2010

(54) Multifunctional Vehicle Wheel System

(75) Inventors: Ma'in Radi Sinan, London (CA); Yazan Ma'in Sinan, London (CA)

Correspondence Address: Ma'in Sinan, 43-786 Shelborne St., London, ON, N5Z4Y5, CA

(73) Assignees: Ma'in Radi Sinan, London (CA); Yazan Ma'in Sinan, London (CA)

(21) Appl. No.: 12/727,400

(22) Filed: Mar. 19, 2010

Related U.S. Application Data
(63) Continuation-in-part of application No. PCT/CA2007/001651, filed on Mar. 19, 2010.

(30) Foreign Application Priority Data
Sep. 19, 2007 (CA) PCT/CA2007/001651

(51) Int. Cl. F02G 5/02

(52) U.S. Cl. 60/613

(57) ABSTRACT

This invention relates to transportation and energy production technologies, capture and storage of exhaust gases of vehicles, fuel and energy efficiencies of vehicles, electrical production within vehicles and reducing the environmental harm done by vehicles.

### TECHNICAL FIELD

This invention relates to transportation and energy production technologies, capture and storage of exhaust gases of vehicles, fuel and energy efficiencies of vehicles, electrical production within vehicles and reducing the environmental harm done by vehicles.

### BACKGROUND ART

A motor vehicle in motion has many forces acting on it, mainly the driving force and the forces which offer resistance to its motion. Through their driving force, vehicles' engines have been designed and built to provide power to carry out the following functions, all of these functions of course offer resistance forces to the engine:

Overcome the hydraulic resistances of the admission and exhaust systems

Overcome the aerodynamic resistance caused by pushing the vehicle through the air

Overcome the rolling resistance, this force arises as a result of the operation of the engine and depends on the interaction between the driving wheels and the road. The energy lost due to this resistance force can be categorized in three groups: energy spent on traction, energy spent on deformation of tires and road, and on vibration of the vehicle's suspension system.

Overcome the gradient (gradiability) resistance caused by pushing the vehicle up a sloped surface.

Overcome all mechanical friction in the vehicle's components such as the engine, transmission, driving lines and axles, and brakes.

Provide power for all electrical accessories such as air conditioning, heating, alternator, starter, electrical mirrors, and windows, etc.

Provide power for all the mechanical accessories such as the hydraulic steering pump, water pump, oil pump and the supercharger.

Provide power for rapid acceleration when it is needed or desired by drivers. Rapid acceleration being when the driver sharply opens the throttle and holds it in this position until acceleration is over.

The higher the engine's torque and overall transmission ratio between the engine and driven wheels and the lower the power-transmission losses, the higher is the driving force available the drive wheels. The surplus force—the driving force minus the total resistance forces—accelerates the vehicle (or retards it when the total resistance forces are greater than the driving force). At most speeds, the vehicle actually has a surplus force (used for acceleration); the engines of vehicles are capable of providing significantly greater horsepower than what is required to overcome the forces outlined above. Most of the time, what we require a vehicle's engine to do only uses a fraction of the power that is available. This condition will be capitalized upon within the present invention.

Vehicles which use combustion engines as propulsion release exhaust gases which result from the combustion of fuel within the vehicles' engines into the atmosphere. In these combustion vehicles part of the chemical energy released by combusting a fuel is lost to heat/thermal dynamic losses (this is further increased when there are malfunctions in the engine's operations and wear in the engine's parts), most of this heat goes to the exhaust gases and the cooling system of the vehicle's engine. Part of the rest of the energy not lost to heat/thermal dynamic losses is converted into mechanical work and only part of this mechanical work is used for useful work (the largest loss is from idling—when the engine is standing by). It is also important to note that it has been established that the content of CO and HC in the exhaust gases of petrol engines is maximum at idle run and also with small and maximum loads on the engine.

Generally, the fuel consumption and the speed of a given vehicle with a piston engine have a non-linear relationship where fuel consumption is higher at lower speeds and at maximum speeds and is lower at the speeds in between, the specific speeds of course vary with each vehicle. A very important case in which this property of most piston engines is very harmful for fuel consumption is idling.

Electrolysers are devices which run an electric current through a liquid containing mobile ions in order to separate the molecules of certain materials. Such a process is referred to as electrolysis. A very simple electrolyser is one which runs an electric current through water, separating the H2O molecules into H2 and O2 molecules, thus producing hydrogen and oxygen. Also, an increase in the thermal energy of the liquid to be used in a given electrolyser reduces the necessary amount of energy required (activation energy) for electrolysis of the liquid.

Fuel cells are in summary batteries which can take a continuous supply of fuel and oxidant. A fuel cell comprises an anode side, an electrolyte and a cathode side. In order to generate electricity, a fuel cell is supplied with fuel on the anode side, and oxidant on the cathode side. An example fuel-oxidant combination is hydrogen (as fuel) and oxygen (as oxidant), certain fuel cells can take this combination and as a result produce electricity and water. Two particular types of fuel cells that can use hydrocarbons as fuel are carbonate fuel cells and solid oxide fuel cells; for example these fuel cells may even take in HC molecules and CO molecules as fuel.

Also both the performance of a fuel cell and the performance of an electrolyser benefit from an increase in pressure of their fuel/oxidizer and solution to be electrolysed respectively.

Cavitation, the powerful force generated when tiny bubbles collapse around mechanical devices operating in liquid media, has long been viewed by science as a destructive process to be eliminated. mitton valve technology is a way to eliminate the mechanically damaging effects of cavitation and safely harness its power to cleanly separate and entrain gases and liquids in a simple, compact chemical reactor. The mitton harnessed cavitation reactor offers a low energy, scalable, easy to incorporate system that can remediate wastewater across the entire spectrum of industrial processes.

U.S. Pat. No. 6,164,263 and U.S. Pat. No. 6,899,075 show the exemplary elements of a Quasiturbine suitable for use with the invention, and are hereby incorporated by reference in their entirety.

US Patent No. 20090065724 and WO 2006053414 show the exemplary elements of a mitton valve suitable for use with the invention, and are hereby incorporated by reference in their entirety.

### DISCLOSURE

### Technical Problem

The first problem is that vehicles release exhaust gases which result from the combustion of fuel within the vehicles' engines into the atmosphere.

The second problem is due to the relationship between the fuel consumption of a given vehicle with a piston engine and the speed of this vehicle as stated in the background art; for example, an idling vehicle has significantly higher fuel consumption than a vehicle moving at average speeds. It is very common for a driver to turn on the vehicle several minutes before moving the vehicle so that the heater may have time to raise the temperature inside the vehicle to a comfortable level or so that the air conditioner may cool it, etc. This period of idling is both negative for mileage and the environment.

The third problem is that (as is well known in the art) after the exhaust phase of a combustion engine, there remains some exhaust gases in the piston as a fresh charge (fuel-air mixture) is admitted into the given piston during the next cycle. These residual exhaust gases decrease the amount of charge admitted into the piston in two ways, first and most obvious is that the presence of these residual gases means less charge can be admitted. Second, the extremely high temperature of these residual gases increases the temperature of the admitted charge which thus decreases the density of the admitted charge which means less charge is admitted into the piston which of course decreases the volumetric efficiency of that engine.

The forth problem is that most piston engines are configured so that the exhaust gas valve for any given piston within the engine is open before the end of the expansion phase—meaning that the piston begins releasing exhaust gases before the expansion phase is complete. This is done so that the exhaust gases have sufficient energy to counteract the hydraulic resistance they encounter flowing through the exhaust system of the vehicle (this hydraulic resistance is due to the fact that the exhaust gases have to push past air and other factors as they travel out of the exhaust system). This of course also means that some energy which could have been used for mechanical work during the expansion process is instead used to counteract this hydraulic resistance of the exhaust gases.

### Technical Solution

The present invention is a system designed to:

1. Capture, compress and store a vehicle's exhaust gases

2. Increase the fuel and energy efficiencies of a vehicle.

3. Reduce the negative effect of idling on fuel consumption by reducing the load on the engine at idle speed

4. Reburn, reform and recycle a vehicle's exhaust gases.

5. Generate some or all of the vehicle's electricity

6. Use the surplus/excess/unused engine power described above.

7. Can be incorporated into new vehicle designs and vehicles that are already on the road (since most of the components of this invention are within the wheel of the vehicle).

There is an ever increasing concern today about the impact combustion based industry is making on the environment, namely with the production and release of CO2 into the atmosphere. This of course includes internal combustion vehicles. The main function of the present invention is to capture and store the exhaust gases of a vehicle—in some cases possibly all of the vehicle's exhaust gases. Further embodiments of the present invention can also improve the fuel and energy efficiencies of the vehicle, reduce or eliminate idling, reburn the vehicle's exhaust gases, reform the vehicle's exhaust gases, recycle the vehicle's exhaust gases and generate some or all of the electricity needed within the vehicle. All of this is accomplished while using surplus engine power and while keeping it possible for the present invention to be incorporated into new vehicle designs and vehicles that are already on the road.

There has been some progress new vehicles with lower fuel consumption; however, there is as of today over 750 million vehicles on the road, all of them producing exhaust gases and all of them releasing these exhaust gases into the atmosphere. If meaningful action is to be done in order to preserve the environment and avoid the scientifically proven damages on the atmosphere and the environment caused by these vehicles, the over 750 million vehicles with combustion engines on the road today must also be addressed. The present invention has the decisive advantage of being possible to incorporate into any vehicle with only the restriction that this vehicle has a wheel and an internal combustion engine. This means all of the over 750 million vehicles with combustion engines on the road, all of the vehicles with combustion engine currently in production and all of the vehicles with combustion engines that will be produced well into the future.

Industry is currently experimenting with the idea of capturing and storing the CO2 generated by factories and power generation plants, little thought has gone into capturing and storing the CO2 (and other harmful gases) that are released by vehicles, this invention addresses this in a new and novel way. The present invention acts to capture and store some if not all of the given vehicle's exhaust gases. Some embodiments of the present invention also go even further and reburn or enrich and reburn the exhaust gases to harness some of the energy of the unburned fuel remaining in the exhaust gases, reform the exhaust gases into synthetic fuel or reform the exhaust gases into synthetic fuel and reburn this synthetic fuel onboard the vehicle on demand.

What can be done with any remaining unreformed exhaust gases after their capture and storage by the present invention is a market of it's own. These exhaust gases can of course be emptied from the vehicle and possibly stored in ways similar to those now being used for the harmful gases of some factories and power plants, such as permanent underground storage. These remaining exhaust gases can also be used by industry to be reformed into synthetic fuel, carbon fibers and many other useful materials. In the case of reforming the captured exhaust gases into synthetic/hydrocarbon fuel, since upon combustion in a vehicle having the present invention this synthetic/hydrocarbon fuel will produce CO2 which is then captured again and converted back into synthetic/hydrocarbon fuel, this synthetic/hydrocarbon fuel can be regarded as a renewable inexhaustible resource as opposed to hydrocarbon fossil fuels which are exhaustible; the advantages of such an industry created by the present invention in which synthetic/hydrocarbon fuel is a renewable and inexhaustible resource are significant.

To highlight the advantages of the present invention, let us consider other possible systems which can capture and store the exhaust gases of a vehicle.

The first and most obvious solution would be simply to use an electric pump and compressor powered by the vehicle's alternator to capture the exhaust gases of the vehicle into a storage unit. This system can be placed in the trunk of the vehicle, under the vehicle or some other location where there is unused space. There are several disadvantages of this system which the present invention addresses. The first is that this system requires a substantial amount of electrical energy. The electrical energy needed to power such a system will be powered by the vehicle's alternator. The alternator's of modern vehicle's continue to be powered by the given vehicle's engine when the vehicle is in idle, as when the vehicle is at idle the engine is still running. This means that this possible system will also draw power from the vehicle's engine at idle. Recall as mentioned that most vehicle's fuel consumption at idle is high. On the other hand, the present invention is powered by the wheel rim, and since the wheel rim does not rotate at idle, the present invention does not draw power from the vehicle's engine at idle, avoiding the significant increase in fuel consumption of idle. Also, some embodiments of the present invention further include an electric motor which powers pumps and/or compressors within the system for capturing and storing the vehicle's exhaust gases at idle (as will be detailed below), however this electric motor uses electrical energy that is generated by the present invention (this will also be detailed shortly) when the vehicle is not in idle, therefore such an embodiment is also better for fuel consumption than the abovementioned other possible system. The present invention uses surplus power and torque of the vehicle's engine at most speeds, this means that at those speeds (the majority of the time) the vehicle will only use slightly more fuel powering the present invention than it would without it. The second disadvantage of this electrically powered pump and compressor system is that it will be necessary to control the pump and compressor with some electronic control unit so that this possible system can adjust the rate at which it captures the exhaust gases to even be remotely close to the rate at which the exhaust gases are produced, since of course the rate at which exhaust gases are produced varies depending on the continuously changing speed of the vehicle (among other variables). The present invention addresses this issue without a electronic control unit, since the present invention uses the vehicle's wheel to power the pumps and compressors within it; the wheel provides a reliable approximation for the changes in the rate of production of exhaust gases at most speeds, since as the vehicle's speed increases (or decreases), the rate of production of exhaust gases increases (or decreases) and the wheels' RPMs also increase (or decrease). Of course some embodiments of this invention may use a electronic control unit for more accurate measurements and other functions as will be detailed below, however the advantage remains that the present invention's exhaust capture and storage can function fairly accurately without one, meaning that the present invention can be produced at much less costs if need be. A third disadvantage of this possible system is that in most cases it will require the use of space within the vehicle that would otherwise be used for storage. The present invention also has the advantage of using what is usually free space within the vehicle (the wheel rim) for most of it's components; usually the wheel rim within a vehicle houses only a brake, this means that by incorporating the present invention into a vehicle, no loss of storage space nor any inconvenience is required.

Another possible system which can capture and store the exhaust gases of a vehicle using a piston engine is one that uses some of the pistons within this engine. In this solution one or more of the pistons of the engine (the number of pistons of course depends on the engine, the vehicle, etc.) are used as pumps and compressors only, and not for combustion. Here the exhaust gases released from the other pistons (which are used for combustion) are pumped through a connection between the pistons which are used for combustion and between the pistons being used as pumps and compressors and into the pump/compressor pistons by the pump/compressor pistons themselves and where these pistons then compress the exhaust gases into a storage unit. Of course the pistons used as pumps and compressors either have no spark plugs at all or have their spark plugs deactivated while they are in use as pumps and compressors. This possible system has a significant disadvantage which is addressed with the present invention; mainly, this solution requires either a great deal of work, configuration, extensions and modifications in order to adapt a normal piston engine for this functionality or simply a brand new engine designed for this purpose. This means that this possible system would be very costly to incorporate in a vehicle already on the road or in production today, as it would either require a great deal of expense in adapting the engine or the cost of a brand new engine. The present invention is much more practical to produce and incorporate in a given vehicle and is also a much more economic option for the over 750 million vehicles already on the road today. It must be noted, that the concept of using some pistons within a piston engine for this functionality and similarly the concept of using some circuits within a rotary engine (eg: Quasiturbine) for pumping and compressing exhaust gases while using the pistons/other circuits in the very same engine for the actual engine cycles (for propulsion) is used with some embodiments of the present invention, in the case of the piston engine a rotary piston engine is used within such an embodiment of the present invention, this will be detailed below.

Another useful advantage of the present invention can be seen in the embodiments of the present invention which incorporate a rotary and/or electric engine (when referring to a rotary engine in this patent this includes a Wankel rotary engine, a Brayton rotary engine, a Quasiturbine rotary engine, a piston rotary engine or Stirling-heat rotary engine) and which use this engine to drive the vehicle at speeds where the rotary and/or electric engine is more fuel efficient than the vehicle's engine. This of course significantly decreases the fuel consumption of the given vehicle. These embodiments are infact incorporating one of the most common hybrid vehicle techniques in a novel way into non-hybrid vehicles—that is, using an engine other than the vehicle's engine to drive the vehicle at those speeds where it's engine is least fuel efficient, usually at the lower speeds and at takeoff. This means that a vehicle using those embodiments of the present invention can in fact be hybridized after production—a new concept; more generally such embodiments of the present invention—among many other functionalities, such as the capture and storage of exhaust gases—make it possible to hybridize almost any non-hybrid vehicle with only the restriction that it has an internal combustion engine and a wheel.

This invention also addresses the idling problem with the embodiments of the present invention which use the wheel to generate the vehicle's electrical energy. This functionality can replace or complement the vehicle's regular alternator—by ‘replace’ the regular alternator we mean that the regular alternator will no longer be needed and thus can be removed. In the case of replacing (eliminating the need for) the vehicle's regular alternator, this minimizes the load on the vehicle's engine at idle time since the regular alternator is no longer putting a load on the engine at idle, and since the wheels are not moving at idle the alternator(s) within such an embodiment of the present invention will not put a load on the engine at idle (since the alternator(s) within such an embodiment are powered by the wheel), this of course decreases the vehicle's overall fuel consumption (since fuel consumption at idle is very high). Also, such an embodiment of the present invention can be used to completely eliminate idling by using the generated electricity to heat the vehicle's engine and power the heater/air conditioner of the vehicle before start-up—removing most of the incentive to idle.

As a result of pumping the exhaust gases of the vehicle out of the exhaust system, there will be less and possibly no remaining residual exhaust gases within the piston for the admission strokes, meaning that each new cycle of the piston engine can be in fact a new fresh cycle without remaining residual exhaust decreasing it's volumetric efficiency. Of course, since the presence of residual exhaust gases decreases the volumetric efficiency of the engine, the present invention will thus improve the engine's volumetric efficiency by reducing or eliminating the presence of these residual exhaust gases. The higher charge density in the admission phase of the the vehicle's engine resulting from the present invention will increase the charge mass and the power-per-liter of the given engine, since in this case more fuel is burned in a unit of a cylinder working volume. This advantage of the present invention is significant as it solves a problem within internal combustion engines that has virtually been accepted as necessary, this resolution resulting in an increase in the given vehicle's power. Due to this decisive advantage, it is conceivable that older vehicles that have neither a supercharger nor a turbocharger can with the present invention retain the benefits of these technologies as well as the other varied benefits of the present invention. It is also conceivable that newer vehicles need no longer be built with a supercharger or turbocharger thus reducing cost while retaining all of the advantages of these technologies as well as having the other advantages of the present invention by incorporating the present invention.

Given the function of the present invention, it is clear that the decreased pressure, vacuuming action and pumping action performed by the present invention's pumps on the exhaust system causes a rapid release of exhaust gases from the vehicle's engine and reduces and possibly eliminates the need for the premature exhaust release described in the technical problem section. In other words, the cycle of the engine of a vehicle incorporating the present invention need not be configured to begin expelling exhaust gases before the end of the expansion phase, it can be configured to begin expelling the exhaust gases when the piston reaches the bottom dead centre in the expansion phase, and can thus use this energy that would have otherwise been lost to expelling the exhaust gases for useful mechanical work within the vehicle, thus very likely increasing the fuel and energy efficiencies of the given vehicle.

### Technical Description

Compressive device: A device which when powered acts to pump a gas or a fluid across a distance and which acts to at least slightly compress this gas or fluid. Also, in the context of this invention, a pump is considered to be a compressive device.

Drive mechanisms: A mechanism which takes mechanical power as input and which redirects at least a portion of this mechanical power as output. Also, in this description when referring to a rotating device A and a device B where there is a apparatus rotating device B by using the rotational energy of device A, device A can be said to be driving device B and this apparatus can be said to be the drive mechanism.

Fluidically connected: Device A is fluidically connected to device B means that there exists a connection between devices A and B such that exhaust gases may flow from ethir A to B through this connection, or from B to A through this connection or both from A to B and from B to A through this connection. Also, when referring to an ‘exhaust conduit’, this ‘exhaust conduit’ is a fluidic connection.

Gas storage unit: A unit which can hold exhaust gases.

In the context of the invention, a transducer is a device that converts one type of energy into another type of energy or converts one type of motion into another type of motion. As examples, when a wheel of a vehicle of the invention is going downhill, and thus gathering mechanical energy in the form of wheel rotational energy, that energy can be transduced by a generator operatively coupled to the wheel into electrical energy, or can be transduced by a compressor operatively coupled to the wheel into gas pressure energy as the compressor pushes the exhaust gasses into the at least one storage unit. Possible transducers include electrical generators, electrical alternators, rotary engines (Wankel, Brayton, Quasiturbine and Piston rotary), electrical power inverters and turbines.

In the context of this invention a Quasiturbine circuit is a path through the Quasiturbine that an input gas/fluid can take which is at least partially sequestered from the other paths.

This invention is to be used within a vehicle which produces exhaust gases as a byproduct of burning a fuel mixture and which has an engine (which we will refer to as the vehicle's engine) and which has at least one wheel rim that is at times rotating, all embodiments of this invention include the following structure:

1. One or more drive mechanisms which can use the rotation of at least one wheel rim on the vehicle or a hub connected to a wheel rim on the vehicle, or a wheel axle shaft directly connected to a hub connected to a wheel rim on the vehicle, or a mechanism which is directly connected to a wheel rim on the vehicle, or a mechanism directly connected to the hub of a wheel rim on the vehicle to drive a desired device.

2. A combination of devices fluidically connected to receive the exhaust gases chosen from a group that will be detailed shortly, each of these devices being drivable by one or more of the above mentioned drive mechanisms. Each of these devices can be either a pump which is fluidically connected to receive the vehicle's exhaust gases or a combination of a pump and a compressor where this pump is fluidically connected to receive the vehicle's exhaust gases and where the compressor is fluidically connected downstream from the pump.

3. One or more gas storage units fluidically connected downstream from the above mentioned pumps and compressors.

The connections that allow the above mentioned pumps/compressors to receive the exhaust gases can be connected to anywhere along the exhaust system of the vehicle (including the exhaust valves' ports/outlets of the vehicle's engine). Within this patent, we consider the exhaust system of the vehicle to include any path which the vehicle's exhaust gases can take, this clearly includes any path which starts at the exhaust-valve-ports/exhaust outlets of the vehicles engine and ends at a tail pipe; as such the connection between the aforementioned devices (pumps/compressors) and the exhaust system can meet the exhaust system anywhere along these paths.

Any such connections within the present invention, such as the connections that allow the above mentioned pumps/compressors to receive the exhaust gases and the connections which connect the gas storage units downstream from the pumps/compressors can simply be any connection through which exhaust gases can flow, such as but not limited to a tube structure.

It must be noted, that when referring to a wheel rim that is at times rotating, wheel rims of both driving and driven wheels are included. Generally for the purposes of this patent, when referring to a wheel rim we are referring to either a driven or driving wheel rim with no distinction. A given vehicle can include as many embodiments of the present invention as it has wheel rims.

In this description when referring to ‘the wheel rim of’ a particular embodiment of the present invention, we are referring to a wheel rim which is being used to drive pumps/compressors within that embodiment of the present invention, or a wheel rim which is connected to a wheel axle shaft which is being used to drive pumps/compressors within that embodiment of the present invention, or a wheel rim which is connected to a mechanism which is being used to drive pumps/compressors within that embodiment of the present invention, or a wheel rim which is connected to a hub which is being used to drive pumps/compressors within that embodiment of the present invention, depending on what is being used to drive the pumps/compressors within that embodiment of the present invention.

Each of the aforementioned drive mechanisms used to drive one or more of the devices fluidically connected to receive the exhaust gases is a device that is connected to the wheel rim or to a hub connected to this wheel rim, or to a wheel axle shaft directly connected to a hub connected to this wheel rim, or to a mechanism which is directly connected to the wheel rim, or to a mechanism which is connected to the wheel rim's hub in a way that when the wheel is rotating—usually as a result of the vehicle's engine's torque—this drive mechanism drives one or more of the aforementioned devices. Any device which takes torque as input and is capable of transmitting this torque or part of this torque as output can be used as anyone of the these drive mechanisms or any other drive mechanisms within the present invention—for example a planetary gear mechanism. These drive mechanisms can include (but are not limited to) any combination of the following: a hub, a nave, a plate, the wheel rim itself, a connection to the wheel rim, a wheel axle shaft connected to a hub connected to the wheel rim, a brake, a gear mechanism, a planetary gear mechanism, a planetary gear mechanism where the ring gear is connected to and rotated by the wheel rim and a planetary gear mechanism where the ring gear is formed on the inner surface of the wheel rim (the inner surface of the wheel rim has gear teeth so as to act as the ring gear). In several embodiments of the present invention these drive mechanisms have a mechanism which can permit free rotation on demand between the wheel rim and the one or more devices being driven. More generally, in the case of drive mechanisms within the present invention which are not connected to the wheel rim and which will be detailed shortly, permit free rotation on demand between any combination of the devices to which a drive mechanism is connected.

It is also possible and worth noting that for a wheel rim of any embodiment of the present invention, if this wheel rim has a wheel axle shaft (a shaft connected directly to the wheel rim or the wheel rim hub) where this wheel axle shaft rotates as the wheel rim rotates or where the wheel rim rotates as the wheel axle shaft rotates, this wheel axle shaft can be used as a component within one or more of the drive mechanisms which drive the devices fluidically connected to receive the exhaust gases. For example this wheel axle shaft can directly drive one or more of the aforementioned devices, or rotate a gear which drive one or more of the aforementioned devices, etc.

The use of a planetary gear mechanism as one of the drive mechanisms used to drive the devices fluidically connected to receive the exhaust gases or as any other drive mechanism within the present invention has some useful benefits. Since planetary gear mechanisms have a plurality of planet gears as well as a sun gear, they can be used to rotate several devices within the present invention, for example, each planet gear can be used to drive a different pump or compressor or alternator or electrical generator and the sun gear can be used to drive one of these devices as well. Another advantage is of course the use of a planetary gear mechanism to rotate these devices at RPMs (revolutions per minute) much higher than the wheel rim's. It is well known that the wheel rim rotates at RPMs much lower than the RPM of its given vehicle's engine, this RPM reduction is performed by the transmission of the vehicle. It may be desirable in some embodiments of this invention to power the above mentioned pumps and compressors (as well as other devices which will be detailed shortly) at RPMs similar to or higher than the engine's RPMs rather than the lower RPMs of the wheel. In this case a planetary gear mechanism can be used as drive mechanisms used to drive these pumps and compressors at an RPM higher than the wheel's.

### [Capture, Compress, Store a Vehicle's Exhaust Gases]

The capture, compression and storage of exhaust gases is accomplished by using the structure outlined above to power a combination of pumps and compressors which have the exhaust system of the vehicle as input and the gas storage units as output. As the vehicle's wheel rim is rotated, the drive mechanisms connected to the devices (pumps/compressors) fluidically connected to receive the exhaust gases drive these pumps/compressors which then pump exhaust gases from the vehicle's exhaust system through the connections between the pumps/compressors and the exhaust system, into the pumps/compressors and then pump/compress these exhaust gases into the gas storage units (through the connections between the pumps/compressors and the gas storage units). Any pump which has a rotatable mechanism where when this mechanism is rotated/driven a pumping action is performed and any compressor which has a rotatable mechanism where when this mechanism is rotated/driven a compression action is performed or a combined pump and compressor which has a rotatable mechanism where when this mechanism is rotated/driven a pumping and compression action is performed may be used within the present invention.

An effective pump/compressor that can be used is a rotary engine (such as Wankel, Brayton, Quasiturbine or piston rotary engine). It should be noted that rotary engines can easily be used as pumps/compressors with only the modification that they be configured not to ignite the mixture they intake, in this case, by rotating/driving the given rotary engine's rotor, or stator, or both in opposite directions a pumping and compression action is performed. This engine could have its rotor driven by the present invention and its stator held static so as to produce suction and compression strokes that can be used to pump and compress exhaust gases. This engine can also have its ‘stator’ driven by the present invention and its ‘rotor’ held static or the ‘rotor’ and ‘stator’ both driven in opposite directions. This rotary engine can at times be used to propel the vehicle by burning a fuel/air mixture or reburning exhaust gases instead, this feature will be addressed further shortly. When using a given rotary engine as a pump and compressor within the present invention, this rotary engine may simply have no spark plug(s) or have its spark plugs deactivated; in the case of using a rotary engine at times as a pump and compressor and at other times as an engine, the spark plug(s) of this rotary engine can be deactivated when this rotary engine is being used as a pump and compressor and reactivated when it is being used for propulsion.

Another possible device to act as a pump/compressor within the present invention is a compressor wheel as used in a turbocharger. This compressor wheel by having the exhaust line as input can capture and compress exhaust gases in the same manner that it pumps and compresses air into a piston engine when used within a turbocharger. In the case of a compressor wheel, the described rotatable mechanism for the devices which act as pumps/compressors is the compressor wheel itself.

It is possible and in certain cases maybe desirable to have an embodiment of this present invention that further includes one or more rotary engines and/or electric motors which can generate a torque and which are connected to a drive mechanism which can use the torque generated by the one or more rotary engines and/or electric motors to drive the devices fluidically connected to receive the exhaust gases. Thus these devices (pumps/compressors) within the present invention can also be powered/driven by these rotary and/or electric engines. Such an embodiment of the present invention would be capable of capturing and storing exhaust gases at a rate and an amount greater than that provided by only using the basic embodiment of the present invention, this of course would be useful for a situation where the wheel rim's torque is not sufficient to capture and compress all of the vehicle's exhaust gases. It is also clear that the rotary engines and/or electric motors can be used to drive pumps/compressors which are driven solely by these rotary engines and/or electric motors and not driven by the wheel rim/wheel axle shaft/etc.

In such an embodiment of the present invention, one or more of the aforementioned drive mechanisms which drive the pumps/compressors which are also driven by a wheel rim/wheel axle shaft/etc. may also include a mechanism which allows for free rotation on demand between the wheel rim and these pumps/compressors. This will allow such an embodiment of the present invention to continue to pump and compress the exhaust gases of the vehicle while the vehicle is at idle (or more generally, when the wheel rim is not rotating) by driving the pumps/compressors with a rotary and/or electric engine as described above when the wheel rim is not rotating, and using this free rotation mechanism so that the torque generated by the rotary and/or electric engine and the act of driving the pumps/compressors will not act to rotate the wheel rim of such an embodiment of the present invention.

An embodiment of the present invention which uses a rotary engine and/or electric motor to drive one or more of it's pump(s)/compressor(s) can also include an electronic control unit which determines the amount and the rate at which these rotary and/or electric engines power the select pumps/compressors in order to pump and compress exhaust gases. It is also possible to have one or more devices (selected from the same group of pumps/compressors outlined above) which are not driven by a wheel rim/wheel rim hub/wheel axle shaft/etc. (rather than or as well as the devices which are driven by a wheel rim/wheel rim hub/wheel axle shaft/etc. and also powered by the rotary and/or electric engines), drivable by the rotary and/or electric engines and also fluidically connected to receive the vehicle's exhaust system and fluidically connected upstream from the gas storage units so that that the rotary and/or electric engines generates a torque, part of this torque is used to drive these devices in order to pump and/or compress the exhaust gases of the vehicle into one or more of the gas storage units.

The gas storage units used to store the compressed exhaust gases can be any storage unit which can store gases, this includes (but is not limited to) the wheel rim itself being sealed, a sealed section of the wheel rim, another wheel rim within the vehicle being sealed, a sealed section of another wheel rim within the vehicle, a cavity in the bumper of the vehicle, a tube structure within the vehicle (where exhaust gases are stored within the tubes of such a structure), a pipe structure within the vehicle (where the exhaust gases are stored within the pipes of such a structure) and the tire of a wheel within the vehicle. In the case of a wheel rim within the vehicle being one of the gas storage units within the present invention, it is possible to also use a sealed section of this wheel rim as a storage unit for the fuel mixture used by the vehicle's engine or one of the rotary engines within the present invention.

### [Improving the Fuel and Energy Efficiencies of a Vehicle]

As detailed earlier, the present invention is likely to improve the fuel efficiency of a vehicle simply as a result of pumping the exhaust gases out of the vehicle's engine's pistons. This function (decreasing the vehicle's fuel consumption/increasing the vehicle's fuel efficiency) is further performed by some embodiments of the present invention in several ways. The first is by using one or more rotary and/or electric engines within the vehicle to drive the vehicle at speeds where these rotary and/or electric engines are more fuel efficient than the vehicle's engine. The second is by using one or more secondary engines within the vehicle to accelerate the vehicle during rapid acceleration. The third is by reducing the load that the vehicle's engine has to carry at idle. The forth is by reburning/reusing and recycling the vehicle's exhaust gases.

The first three techniques used within some embodiments of the present invention to improve the fuel and energy efficiencies of a vehicle (with the exception of reburning and recycling the vehicle's exhaust gases) can be summarized with the following simple concept, highway driving vs. city driving. It is well known that most vehicles are much more fuel efficient during what is referred to as highway driving. This is due to mainly three reasons; first at highway driving the vehicle is being driven at operational points and speeds where it is more fuel efficient, second during what is referred to as city driving there is a great deal of rapid acceleration, coasting, deceleration and braking which increases the fuel consumption of the vehicle, and third during what is referred to as city driving the vehicle at times is in idle—significantly increasing the vehicle's fuel consumption. Some embodiments of the present invention use one or more rotary and/or electric engines to drive the vehicle at the operational points and speeds where the vehicle's engine is less fuel efficient. Also some embodiments of the present invention use one or more rotary and/or electric engines which are more fuel and energy efficient at rapid acceleration to accelerate the vehicle when it is in rapid acceleration. Also some embodiments of the present invention act to reduce the load the vehicle has to carry at idle—thus reducing the negative effect of idling on fuel consumption of the vehicle. In summary these three techniques used within some embodiments of the present invention allow the vehicle to operate at highway driving fuel and efficiency while it is in fact in city driving conditions.

The usage of the one or more rotary and/or electric engines for propulsion of the vehicle is an important embodiment of this invention. Each of these rotary and/or electric engines can be connected to a drive mechanism which uses the torque generated by this rotary and/or electric engine to drive the wheel rim of such an embodiment of the present invention, whereby the rotary and/or electric engine can rotate this wheel rim on demand and thus drive the vehicle. Each of these engines can be a rotary engine (such as Wankel, Brayton, Quasiturbine or piston rotary engine). Such an engine may burn a fuel/air mixture to propel the vehicle or reburn captured exhaust gases (which will still have some combustible material in them, since the internal combustion engine's combustion is not complete) for minor propulsion or reburn exhaust gases that have been enriched by a fuel/air mixture (such as hydrogen). In the case of a rotary engine, the rotary engine can be the very same engine that is at times used to pump and compress the exhaust gases of the vehicle where it is used at times to pump and compress the exhaust gases and at other times as propulsion.

When using a given rotary engine within an embodiment of the present invention at times as propulsion and at other times to pump and compress exhaust gases the drive mechanism which uses the torque generated by this rotary engine to drive the wheel rim can be the same drive mechanism which drives the rotary engine in order to pump and compress exhaust gases when this rotary engine is being used as a pump and compressor, provided that this drive mechanism can also transmit a torque from the wheel rim and to the rotor and/or stator of the rotary engine. In this case, when this rotary engine is being used as one of the pumps/compressors within such an embodiment of the present invention this drive mechanism drives the stator or rotor of the rotary engine (or both in opposite directions) as the wheel rim rotates and thus this rotary engine performs a pumping and compression action.

To address the problem outlined above relating to the high fuel consumption of piston engine vehicles at lower and maximum speeds, a rotary engine within an embodiment of the present invention can be used for propulsion of the vehicle where the vehicle's engine (in this case a piston engine) is used to propel the vehicle at speeds where it is more fuel efficient then the rotary engine and this rotary engine can be used to propel the vehicle at speeds where it is more fuel efficient than the vehicle's engine. This of course will decrease the fuel consumption of the vehicle.

An electrical engine/motor can also be used for propulsion of the vehicle in the same fashion, if this motor is being used in an embodiment of the present invention which also generates electricity, this motor may also be powered by the electricity generated by such an embodiment of the present invention as will be outlined shortly.

In the embodiments of the present invention which have one or more rotary and/or electric engines for propulsion of the vehicle, one or more of these rotary/electric engines can at times also be used as one of the rotary and/or electric engines which power pumps/compressors within the present invention as described.

Another possible engine to be incorporated within the present invention and to be used for the vehicle is a pneumatic engine (possibly a Quasiturbine-pneumatic engine) which uses the compressed exhaust gases for minor propulsion and can be used to propel the vehicle at very low speeds for relatively short periods of time. Such an engine would release some of the compressed exhaust gases and direct them to a rotor which is capable of turning at least one wheel rim within the vehicle so that as these compressed exhaust gases turn the rotor the wheel(s) connected to the rotor also turn. Such an engine would be useful in situations such as drive-through restaurants where the vehicle is mostly stationary and for the short periods where it is moving is moved for only a few meters. The released exhaust gases can be directed to a temporary storage compartment and can be compressed again by the present invention when the vehicle returns to higher speeds.

In the case of utilizing a rotary and/or electric engine within certain embodiments of the present invention to propel the vehicle, the drive mechanism which uses the torque generated by this engine to drive the wheel rim of that embodiment of the present invention may include a mechanism which can permit free rotation between the rotating components of the rotary and/or electric engine and the wheel rim on demand so that it is possible for the rotary and/or electric engine to run (in the case of a rotary engine, burn a fuel mixture or reburn exhaust gases) without rotating the wheel rim. In the case of using the rotary and/or electric engine to power pumps and compressors within some embodiments of the present invention as will be outlined shortly, this would mean that such an embodiment of the present invention may pump and compress exhaust gases while the wheel rim is not rotating and/or while the vehicle is idling.

It is possible to configure a rotary engine to act as a propulsion for the vehicle as outlined above as well as act as one of the pumps/compressors within the present invention at the same time. This can be accomplished by using a Quasiturbine rotary engine or a piston rotary engine. In the case of the Quasiturbine engine, it is possible to configure such an engine to function with two independent circuits. One of these circuits can be used to accomplish the propulsion functionality (as outlined above) and the second circuit can be used as one of the pumps and compressors within the present invention which pumps and compresses the exhaust gases of the vehicle into the gas storage units. Then second circuit would be rotated and powered by the first circuit as the first circuit combusts a fuel mixture. It is also possible to use the second circuit to pump and compress the exhaust gases of the Quasiturbine engine itself into one or more of the gas storage units, or to pump and compress the exhaust gases of the Quasiturbine engine and the vehicle's engine into one or more of the gas storage units at the same time. The same can be accomplished with a piston rotary engine having at least two pistons, where a group of pistons burn the fuel mixture (as outlined above) generating torque while a second group of pistons (having the same crankshaft as the first group of pistons) are used as some of the pumps and compressors within the present invention which capture the exhaust gases of either the vehicle's engine or the piston engine itself or both as the first group of pistons burns a fuel mixture and thus rotates the crankshaft which thus drives the second group of pistons; of course, the pistons within this piston rotary engine which are used as pumps and compressors will either not have spark plugs or have their spark plugs deactivated. More generally, a piston rotary engine within an embodiment of the present invention can be configured to operate 2 or more independent circuits.

It is well known that the fuel consumption of a vehicle grows with an increase in the resistance forces of the cycle of acceleration, deceleration, braking coasting (motion due only to inertia) when a motor vehicle is accelerated. During acceleration, a force must be applied to accelerate (and increase the kinetic energy) of the components powered by the engine, this includes the pistons, the transmission's rotating components, etc, this of course requires more energy and therefore the total consumption of fuel increases.

In some embodiments the present invention may be used to diminish the fuel consumption by using one or more Quasiturbine engines (or a rotary/electric engine in general) to accelerate the vehicle during rapid acceleration (the use of one or more rotary and/or electric engines within the vehicle to accelerate the vehicle during rapid acceleration is another method some embodiments of the present invention employ to decrease the fuel consumption of the vehicle). By it's design a Quasiburbine is known to be more effective at rapid acceleration than a piston engine, as detailed in the Quasiturbine patents, one of the reasons is that a Quasiturbine generally has less mechanical friction than a piston engine. Also, since such a Quasiturbine engine in such an embodiment of the present invention is in the wheel rim or close to the wheel rim, the transmission between the rotary engine and the wheel will have much less components than the transmission between a regular piston engine and the wheel; also since this rotary engine has less moving parts than a regular piston engine, much less energy (and thus much less fuel) is needed to accelerate the vehicle with this rotary engine than would generally be needed to accelerate the vehicle with a piston engine, as there are less components to be accelerated (for example, a Quasiturbine engine does not have a flywheel).

Any of the rotary engines within embodiments of the present invention can also have a connection (through which exhaust gases may flow) between their exhaust outlet and one or more of the devices (pumps and/or compressors) within the present invention; as mentioned, these devices have a connection between themselves and the storage units of the present invention through which exhaust gases may flow. This of course will mean that as the exhaust gases of the vehicle's engine are being captured and stored by the pumps/compressors within the present invention, the exhaust gases of the rotary engine will also be captured and stored by the pumps/compressors within the present invention.

The second methodology used by some embodiments of this invention to decrease the fuel consumption of the vehicle is to reduce the load that the vehicle's engine has to carry at idle. As mentioned in the background art, the fuel consumption of a given piston engine is very high at lower speeds, especially idle.

Some embodiments of the present invention, by having one or more alternators/electrical generators within it being powered/rotated by the wheel rim as a replacement or compliment to an alternator powered/rotated directly by the vehicle's engine (as is the convention in most vehicles) acts to eliminate or reduce the load that the vehicle's alternator would place on the vehicle's engine at idle, since the wheel does not rotate at idle speed.

Alternators/electrical generators within such an embodiment of the present invention are powered in a way similar to the way the present invention powers the pumps and compressors within it. Simply, most alternators/electrical generators have a rotatable mechanism (for example a rotor), which when driven the given alternator/electrical generator generates electrical energy. In such embodiments of the present invention, each of these alternators/electrical generators is positioned to be within the wheel rim (or partially within the wheel rim) and is driven by one or more of the aforementioned drive mechanisms which use the rotation of a wheel rim/a wheel rim hub/a wheel axle shaft/etc., so as the wheel rim is rotated the rotatable mechanism of this alternator/electrical generator is driven so that this alternator/electrical generator then generates electricity. This of course means that since the alternator/electrical generator is powered when the wheel rim is moving, it will not add a load to the piston engine of the vehicle when the engine is at idle, since the wheel rim is not rotating at idle.

The use of the alternator/electrical generator within some embodiments of the present invention highlights an important benefit of using a planetary gear mechanism as a drive mechanism within the present invention. It is well known that the wheel rim rotates at RPMs much lower than the RPM of it's given vehicle's engine, this RPM reduction is performed by the transmission of the vehicle. However when powering an alternator/electrical generator, it would be desirable to power the alternator/electrical generator at RPMs similar to or higher than the engine's RPMs rather than the lower RPMs of the wheel. In this case a planetary gear mechanism can be used as a drive mechanism which drives one or more of the alternators/electric generators in such an embodiment of the present at an RPM higher than the wheel's.

In embodiments of the present invention which have both one or more alternators/electric generators and one or more rotary engines, one or more of the alternators/electrical generators within such embodiments of the present invention can also be powered by one or more of the rotary engines within these embodiments. This is done by having the alternator/electrical generator driven by a drive mechanism which uses the torque generated by these rotary engines to drive this alternator/electrical generator, so that as these (one or more) rotary engines burn a fuel mixture (or reburn exhaust gases) they generate a torque which can then be used to drive this alternator/electrical generator to produce electricity.

For the embodiments of the present invention which include alternators/electric generators, in order for the alternators/electric generators such an embodiment to generate electricity when the wheel rim is not moving and/or the vehicle is in idle, one or more of the described rotary engines can be used to drive the alternators/electric generators when the vehicle is at idle. Furthermore, in the case that one or more of these rotary engines is one of the above mentioned rotary engines which is used as propulsion for the vehicle or one which is used to power pumps/compressors, the drive mechanism which uses the torque generated by this rotary engines to the wheel rim could include a mechanism which can permit free rotation on demand between the rotating components of this rotary engine and the wheel rim, so that the rotary engine can on demand power the alternator/electrical generator without rotating the wheel rim and without causing the vehicle to move, this of course would be useful at times where moving the vehicle is not desired (such as at idle).

In the case of any of the alternators/electrical generators within embodiments of the present invention, the generated electrical energy may be sent to a converter/inverter and/or transformers where necessary. The electricity generated by these alternators/electrical generators can be used to:

1. Long-term storage and/or short term storage

2. Power one or more devices for warming the vehicle's engine and/or catalytic converter prior to start-up

3. Power some or all of the electrical accessories within the vehicle

4. Power household appliances

5. Power an electric motor

6. Power an electric motor which at times acts as propulsion for the vehicle.

7. Power a reversible fuel cell.

8. Power a hydrogen-generator/electrolyser

9. Power a hydrogen-generator/electrolyser which acts to produce hydrogen that is sent to the vehicle's engine to be used as fuel.

10. Power a hydrogen-generator/electrolyser which acts to produce hydrogen which is used to enrich a fuel mixture burned for propulsion for the vehicle.

11. Power a hydrogen-generator/electrolyser which acts to produce hydrogen that is sent to one of the above mentioned rotary engines to be used as fuel.

12. Power a hydrogen-generator/electrolyser which acts to produce hydrogen which is used to enrich some or all of the captured exhaust gases prior to reburning them.

13. Power a device for enriching exhaust gases with a fuel/air mixture.

14. Power a device for recycling the captured exhaust gases into a hydrocarbon fuel.

15. Power an electromagnetic brake

16. Power an electronic steering system

### [Reburn and Recycle a Vehicle's Exhaust Gases]

An important function of some embodiments of the present invention is to reburn and recycle a vehicle's exhaust gases after they have been captured and stored. This functionality acts to both decrease the fuel consumption of a vehicle and to significantly decrease and in some cases possibly eliminate the vehicle's greenhouse damage. This is accomplished in several ways including: reburning the exhaust gases, and enriching the exhaust gases and then reburning them. The stored exhaust gases (which will still have some combustible material in them, since the internal combustion engine's combustion is not complete) may be reburned for minor propulsion or enriched with a fuel/air mixture and then reburned; this reburning maybe accomplished by either the vehicle's engine or a rotary engine within such an embodiment of the present invention (such as the aforementioned rotary engines). One way to enrich the captured exhaust gases is by using an electrolyser to produce hydrogen and enriching the exhaust gases with this hydrogen. If this electrolyser (or a device for enriching the exhaust gases with a fuel mixture in general) is being used in an embodiment of the present invention which also includes one or more alternators/electric generators as described, this electrolyser (or more generally a device for enriching the exhaust gases with a fuel mixture) maybe powered by one or more of these alternators/electric generators.

In this description, reforming exhaust gases and recycling exhaust gases are meant to be equivalent terms.

Some embodiments of the present invention may also include a device for recycling the exhaust gases into hydrocarbon fuel; this device may also be powered by one or more electrical generators/alternators within the present invention (if it is being used in an embodiment of the present invention that has one or more alternators/electric generators). The generated (recycled) hydrocarbon fuel can be used for combustion within the vehicle's engine or for one or more of the rotary engines within some embodiments of the present invention to power the given engine.

It should be noted that using an electrolyser to produce hydrogen and then to enrich the captured exhaust gases with this hydrogen is in fact a device for recycling the exhaust gases, since the CO and HC molecules within the captured exhaust gases, being unstable, and at a high temperature will react with the hydrogen to produce hydrocarbon fuels.

Usually, the most difficult part in recycling CO2 into a hydrocarbon fuel is breaking down the CO2 into CO. Enriching the captured exhaust gases with a fuel mixture and then reburning them (as described above, for example reburning them with a Quasiturbine rotary engine) is one effective way to assist with this process, since the high thermal energy of the combustion (reburning) will be imparted to the CO2 that is within the enriched exhaust gases being reburned, this high thermal energy will make breaking them down into CO much easier. Therefore, it is possible for the device for recycling the exhaust gases into a hydrocarbon fuel within some embodiments of the present invention to recycle the captured exhaust gases after they have been enriched and reburned.

It is well known that the exhaust gases of a vehicle can reach very high temperatures, as such when the present invention captures and stores exhaust gases, it is also implicitly temporarily capturing thermal energy that can be put to good use; therefore in some embodiments of the present invention the exhaust gases that are being captured and compressed by the present invention can be used within a device for converting thermal energy into electricity in order to take advantage of the high temperatures of the exhaust gases. An example of this is using the exhaust gases to power a fuel cell, in particular a fuel cell which uses hydrocarbons as fuel to generate electricity such as a carbonate fuel cell or a solid oxide fuel cell. These fuel cells can use the hydrocarbons such as HC molecules (and even the CO molecules) remaining in the exhaust gases as fuel, while the high thermal energy of the exhaust gases would increase the production of electricity by these fuel cells.

Fuel cells function given a continuous flow of the chemical substances used as fuel and as oxidants, as such the often continuous flow of exhaust gases is well suited for fuel cells. Such a fuel cell can also be made as a part of the connection between the exhaust system of the given vehicle and the pumps/compressors within the present invention. Such an arrangement could conceivably eliminate the need for a catalytic converter in that given vehicle, since such a fuel cell would in fact oxidize most of the remaining hydrocarbons (such as HC molecules) and CO molecules within the exhaust gases.

A particular fuel cell design which can also be used is a fuel cell comprising of three tubes all inside one another (the largest tube on the outside, the second largest tube inside the largest tube and the smallest tube inside the second largest tube) where the outer layer of the second tube is coated with either a fuel cell cathode or fuel cell anode material and where the inner layer of the smallest tube is coated with a fuel cell cathode material (if the outer layer of the second largest tube is coated with a fuel cell anode material) or with a fuel cell anode material (if the outer layer of the second largest tube is coated with a fuel cell cathode material) and where the volume within the second largest tube and outside the smallest tube is filled with an electrolyte and where the volume within the largest tube and outside the second largest tube and the volume within the smallest tube have a fuel for this fuel cell or an oxidant for this fuel cell flowing through them depending on the arrangement of the anode and cathode layers.

In the case of any of these devices for converting thermal energy into electricity, having the connection between the pumps/compressors of the present invention and the exhaust system connect to the exhaust system directly at the exhaust valves' ports/outlets of the vehicle's engine will increase the amount of electricity generated, as the exhaust gases will be captured at the point where they have most thermal energy. This electricity can be used to power a combination of the functions detailed above.

It is also well known that most vehicle's engines produce a great deal of thermal energy during operation. Currently vehicle's have thermal energy transfer systems (such as a radiator) to dispose of this thermal energy. Within some embodiments of the present invention, one can use a thermal energy transfer system for useful purposes (as opposed to simply disposing of it as in most vehicles) such as:

1. Heat the captured exhaust gases before they'are used within a device for recycling them into a hydrocarbon fuel (in the embodiments of the present invention where exhaust gases are recycled into a hydrocarbon fuel), this increased thermal energy can be used by any of the chemical processes involved in recycling the captured exhaust gases.

2. Heat the water which will be used within an electrolyser before the electrolyser uses this water to generate hydrogen (in the embodiments of the present invention which use electrolysers), the resulting increase in thermal energy will reduce the amount of applied voltage required to produce hydrogen from this water.

3. Heat the captured exhaust gases prior to their use within the above mentioned device for converting heat into electricity (in the embodiments of the present invention which use such a device), this increase in thermal energy will result in more electrical energy produced.

In the case of heating water which will be used for electrolysis, it is possible to use the captured exhaust gases to do this. One effective way to heat the water with the vehicle's exhaust gases, which can be used in some embodiments of the present invention, is to have the described connection between the pumps/compressors within the present invention and the exhaust system (or the described connection between the pumps/compressors within the present invention and the exhaust gas storage units) of the vehicle take on a tube structure, where there is one tube within an other. The outer tube will allow the exhaust gases to flow from the exhaust system of the vehicle to the pumps/compressors of the present invention. The inner tube can be used to continuously input water into an electrolyser within such an embodiment of the present invention, as the exhaust gases and the water flow through this tube structure, the water will be heated by the very high thermal energy of the exhaust gases.

### Other Aspects of the Present Invention

In the case of using a rotary engine within an embodiment of the present invention to power an alternator/electrical generator within such an embodiment of the present invention, this can be done while having a mechanism which can permit free rotation between the rotating components of the rotary engine within the such an embodiment of the present invention and the wheel rim, so that the rotary engine can on demand power the alternator/electrical generator without rotating the wheel rim.

The drive mechanisms within the present invention can include (but are not limited to) any combination of the following: a disk/disc, an adapter, a rotor, a flange, a web, a spacer, a drum, a stub connected to an axle, a controllable coupling.

In any instance where it was disclosed that a rotary engine can be used in the present invention, it is also possible to use a Stirling-heat rotary engine.

Furthermore some embodiments of the present invention may also include an electronic processing, management and control unit which comprises of data sensors on the present invention (including torque and RPM sensors on the wheel(s)) which monitors the performance and responsivity of other systems within the vehicle incorporating the present invention, collects data from the wheel on both it's speed and power, monitors the difference between the tractive force and total resistance of the vehicle and where applicable manages and controls the production and rate of production of hydrogen, generated electrical energy and rotary engine(s), the capture/compression/reburning and the rate of capture/compression/reburning of the vehicle's exhaust gases, the electronic steering system, the electrical braking system and the performance of the electrical motor(s).

This invention can be incorporated within the wheel rim of a spare wheel which is readily available within the vehicle in case the vehicle gets a flat tire. The embodiment of the present invention in this spare wheel can have some useful applications while the spare wheel is in storage and not in use as a rotating wheel. It is also possible to use any of the described functionalities of the present invention which do not require the wheel rim to be rotating and do not rotate the wheel rim and that are in the particular embodiment of the present invention being used in a given spare wheel rim while the given wheel rim is a spare wheel rim and not rotating.

Also, in the case that the wheel rim of a particular embodiment of the present invention houses a brake having a free centre, the space in the free centre can be occupied by a device within the present invention, such as a pump, compressor, a small quasiturbine rotary engine, or an alternator.

In the embodiments of the present invention which have alternators and/or electric generators, these alternators and/or electrical generators may also be used to power a device for enriching a fuel mixture with another fuel mixture and/or to power an electrical pump and compressor which is also used to pump and compress the vehicle's exhaust gases into one or more gas storage units; this electrical pump and compressor can be placed anywhere in a given vehicle where there is space, such as the trunk and bellow the vehicle.

Also for the embodiments of the present invention which use an electrolyser, the vehicle can include a device for pumping and compressing the oxygen produced in the electrolysis process into the vehicle's engine. This of course will both increase the volumetric efficiency of the given engine (in the same manner with which a turbocharger increases the volumetric efficiency of an engine) and reduce the amount of NOx produced by the given engine (since the gas produced by the electrolysis process will be oxygen and thus will not contain nitrogen).

Vehicle wheels generally comprise a rim, a wheel disc (bear in your mind the “disc” has different names such as nave or web) and a wheel hub (centre of disc). The rim is that part of the wheel on which the tire is mounted. The wheel disc joins the rim to the wheel hub. The wheel hub is that part of the wheel on which the tire/wheel system is mounted. A wheel rim design that can be useful within some embodiments of the present invention has the rim and hub joined together by means of web where this web consists of hollow cylinders, the holes in these shells/cylinders of the web are used for both handling purposes and for acting as housings (and possibly stators) for one or more devices within the present invention, such as the pumps, compressors, electrical generators, alternators, fuel cells, electrolysers, microturbines and Quasiturbines.

It is also possible, in the case that a particular embodiment of the present invention is used within a vehicle having an air conditioning system, to use some of the CO2 in the captured exhaust gases as a refrigerant within this air conditioning system.

Also, as both a fuel cell and electrolyser benefit from an increase in pressure of their fuel/oxidizer and solution to be electrolysed respectively, for the embodiments of the present invention which include either an electrolyser or a fuel cell the embodiment can also include one or more devices for pressurizing the fuel/oxidizer of this fuel cell or the solution to be electrolysed.

An important embodiment of this invention incorporates one or more rotary engines for which the stator of this engine is an elliptical cavity within the wheel rim of such an embodiment of the present invention. In this case, what is usually referred to as the rotor within a rotary engine can be held static and as the wheel rim rotates a volume displacement will occur within this engine and create pumping and compression strokes. This particular arrangement of a rotary engine will of course be capable of acting as a pump and compressor of exhaust gases. This particular arrangement can also serve as one of the possible propulsion rotary engines within some embodiments of the present invention as well as any of the other described rotary engines.

The present invention can also be incorporated on a wheel lying in the middle of an axle with two other wheels on either side of the axle. In this case the wheel rim of such an embodiment of the present invention may also have a differential gear box within it, since the differential is traditionally in the middle (or near the middle) of the given axle. If such an embodiment of the present invention also includes a Quasiturbine engine, the differential gear box can be placed in the central engine area as suggested within the Quasiturbine patent itself.

In the case of having the wheel rim of the present invention be used as a spare wheel rim a drive mechanism which uses the vehicle's engine's torque can be used to drive the devices (pumps/compressors/alternators/electric generators/etc) in that embodiment of the present invention using the spare wheel rim. This arrangement allows the embodiment of the present invention within the spare wheel to have all of the functionalities outlined that would require the wheel rim to be rotating. An example of this would be such that this spare wheel rim is positioned on the hood of the vehicle, and a shaft which is driven by the engine is extended through an opening in the hood of the vehicle and to embodiment of the present invention inside this spare wheel rim in order to drive devices within it.

The spare wheel maybe placed anywhere of convenience within a vehicle, including the front of the hood of a vehicle, outside of the trunk of a vehicle and inside the trunk of a vehicle. It is also possible to use any of the described functionalities of the present invention that are in the particular embodiment of the present invention being used in a given spare wheel rim which do not require the wheel rim to be rotating and do not rotate the wheel rim while the given wheel rim is a spare wheel rim (and thus not rotating). For example, a rotary and/or electric engine which powers pumps/compressors within the present invention independently of the wheel rim powering them can perform this function even when the wheel rim is being used as a spare wheel rim, so that the embodiment of the present invention using the spare wheel rim can also capture, pump and compress exhaust gases. Another example is any use of a rotary engine which has a free rotation mechanism so as not to rotate the wheel rim, such as the use of such an engine to power an alternator/electrical generator so that the embodiment of the present invention using the spare wheel rim can generate electrical energy even when this rim is a spare.

Also, shafts which have gear teeth along their outer surface can be used as gears within the present invention as well as hollow shafts that have gear teeth along their inner surface.

In order to improve the stability of the present invention, some embodiments of the present invention may also incorporate their own suspension structure. This structure takes an inverse U shape where the arms of the U are connected to the main shaft(s) of such an embodiment of the present invention through king pins. The structure consists of coil spring shock absorber(s) on both sides of the inverse U shape and leaf springs on the top of the inverse U shape of the suspension structure. The main leaf spring may also be extended diagonally across the vehicle to meet the main leaf spring of another embodiment of the present invention on the opposing wheel (such as front right wheel to back left wheel, etc.) and thus the leaf springs which are extended diagonally across the vehicle act as a torsion bar/plate within the vehicle. This suspension structure may also be made to have only one half of the U structure.

The coil springs of the coil spring shock absorbers may also be built to be hollow where exhaust gases may flow through them and where they are used as part of one or more of the connections within the present invention through which exhaust gases flow.

Some embodiments of the present invention may further incorporate a modified brake which has gear teeth on its outer surface so as to act as a gear within such an embodiment of the present invention and/or includes a planetary gear mechanism of its own (which has one or more of it's gears rotated by the brake and which may also be placed within the brake). The wheel rim(s) within the present invention may also be sealed and/or divided into multiple sections by using the wheel rim's naves/plates. These naves/plates may also be used as the planetary gears' carriers(s). Different designs for the present invention may use different types of gears, this includes the use of rack and pinion type gears. Also, modified bearings that include gear teeth on their outer and/or inner surfaces may also be used as gears within the present invention.

In accordance with this and other objects, an apparatus for use with a wheeled vehicle, wherein the vehicle comprises an internal combustion engine having an exhaust manifold for directing away exhaust gases produced by the engine, wherein the vehicle comprises at least one wheel disposed for supporting or propelling the vehicle. An apparatus of this invention comprises at least one compressive device and at least one exhaust gas storage unit, wherein the compressive device is fluidically connected to receive at least a portion of the exhaust gases from the engine or from the exhaust manifold, and to direct the gases toward the at least one storage unit; and wherein the at least one compressive device is operatively connected to the at least one wheel by at least one drive mechanism such that operation of the at least one compressive device compresses the portion of the exhaust gases into the at least one storage unit.

In some preferred embodiments, the vehicle comprises at least one brake assembly, and the brake assembly is operatively connected to the apparatus such that operation of the apparatus is initiated when the braking assembly is operating to slow the vehicle such that operation of the apparatus also operates to slow the vehicle.

In some preferred embodiments, the present invention further comprises at least one transducer, wherein the at least one transducer is operatively connected to the apparatus such that energy created or gathered by the vehicle or by the apparatus can be stored or transduced.

In some preferred embodiments, the at least one transducer is selected from the group comprising electrical generators, electrical alternators, rotary engines, electrical power inverters and turbines.

In some preferred embodiments, the present invention further comprises an air/fuel inlet adapted and arranged for introducing into the at least one rotary engine one or more of the exhaust gases from said internal combustion engine, combustion air from the outside atmosphere and one or more fuels from the vehicle fuel storage containment to form an auxilliary combustible mixture, wherein the at least one rotary engine is adapted and arranged to function interchangeably as one or more of a pump, a compressor, and a propulsion device.

In some preferred embodiments, one or more of the rotary engines are Quasiturbine engines adapted and arranged to burn the auxiliary combustible mixture, and wherein the Quasiturbine engines comprise at least one first path and at least one second path for the transmission of first and second gas mixtures, and wherein the first and second paths are separated from one another such that a first function can occur in the first path while a second function can occur in the second path, and wherein the first function is the combustion of the auxiliary combustible mixture, and wherein the second function is the contemporaneous pumping or compression of the exhaust gases into one or more of the storage units.

In some preferred embodiments, the rotary engine is piston rotary engine comprising at least one first set of pistons and at least one second set of pistons, wherein the first set of pistons comprises a first path disposed for performing a first function and the second set of pistons comprises a second path disposed for performing a second function, and wherein the first function is the combustion of the auxiliary combustible mixture, and wherein the second function is the contemporaneous pumping or compression of the exhaust gases into one or more of the storage units.

In some preferred embodiments, the vehicle comprises at least one muffler, and wherein the muffler is fluidically connected to the exhaust manifold such that the operation of one or more of the compressive device and the drive mechanism are tuned to one another in such a way as to reduce the noise made by one or more of the engine, the compressive device, the apparatus, the muffler, and the vehicle.

In some preferred embodiments, the one or more rotary engines are adapted and arranged to compress and store the exhaust gases from the vehicle in the one or more storage units when the vehicle is idling.

### DESCRIPTION OF DRAWINGS

FIG. 1 is a diagram of a wheel which includes a planetary gear mechanism where the rim of the wheel acts as the ring gear.

FIG. 2 is a schematic diagram of a wheel which includes the basic elements of a basic embodiment of the present invention.

FIGS. 3 and 4 show a fuel cell design useful for the present invention.

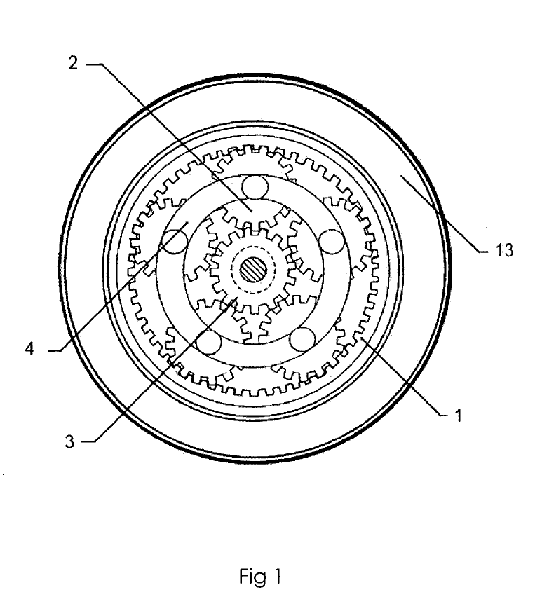

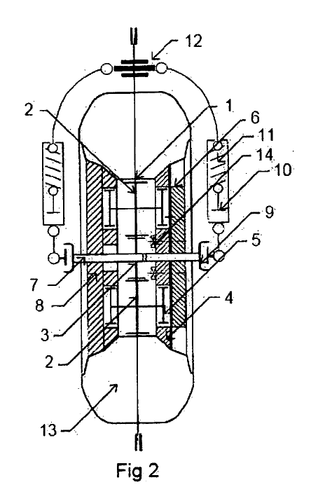

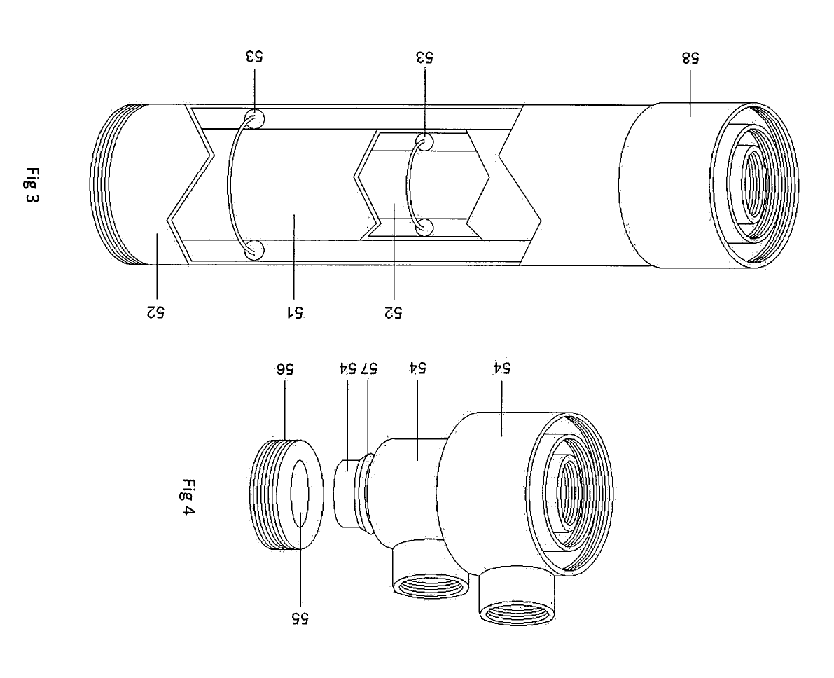

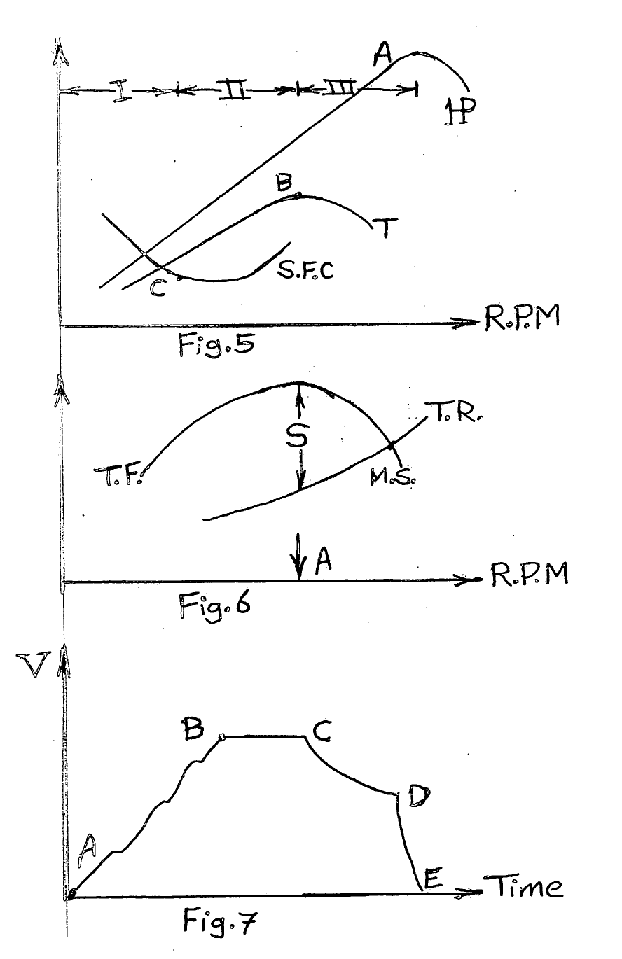

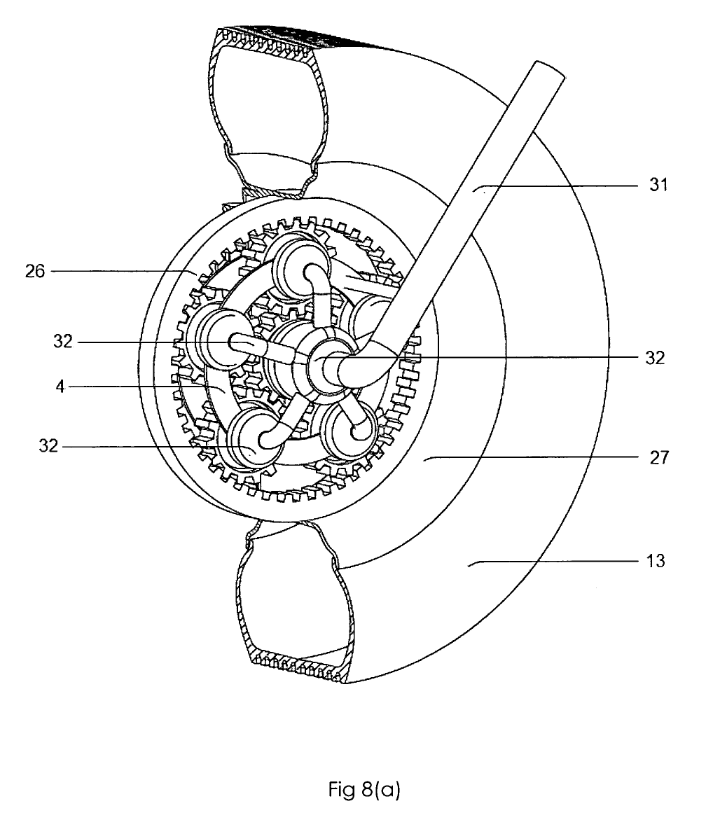

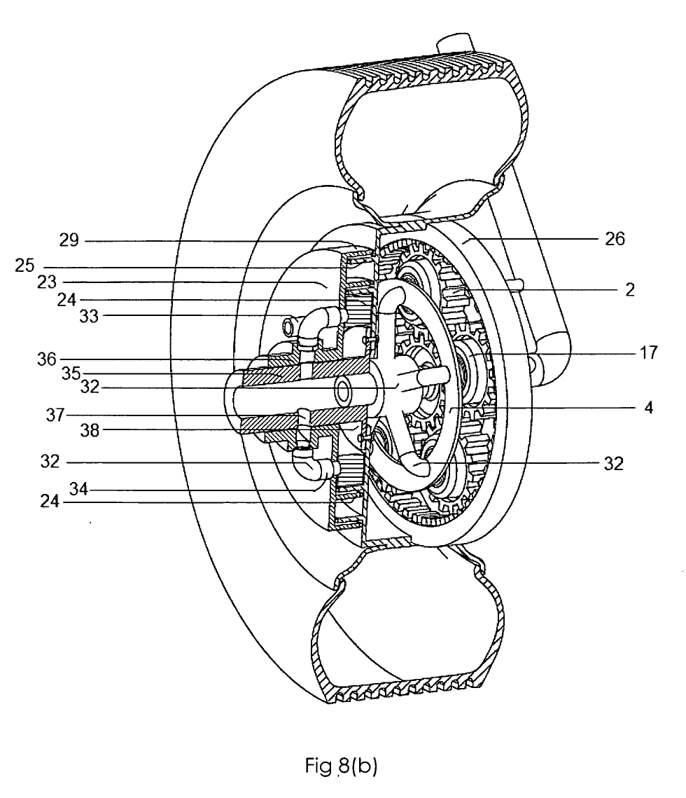

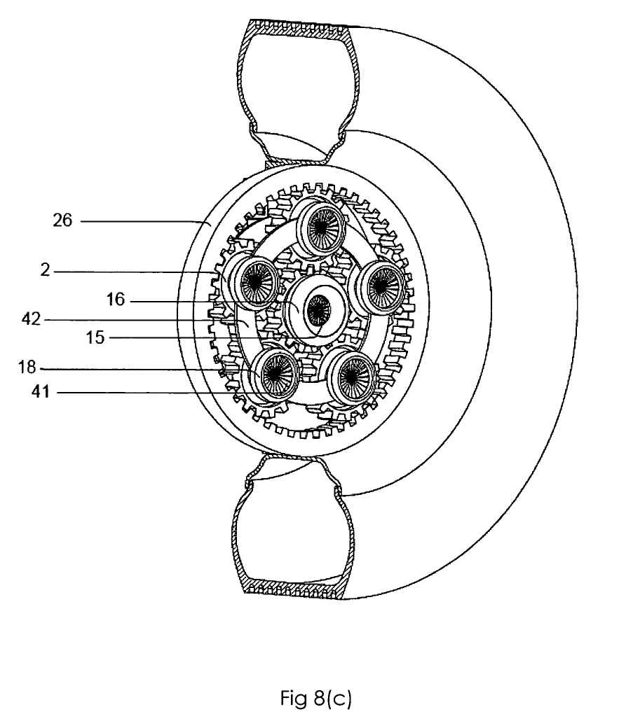

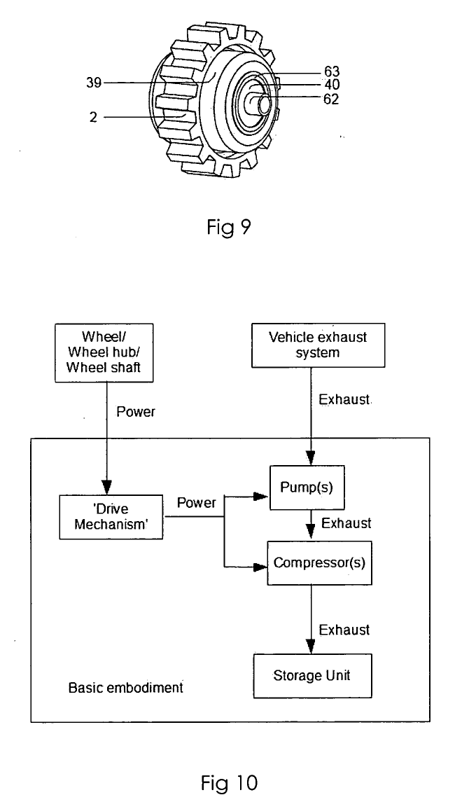

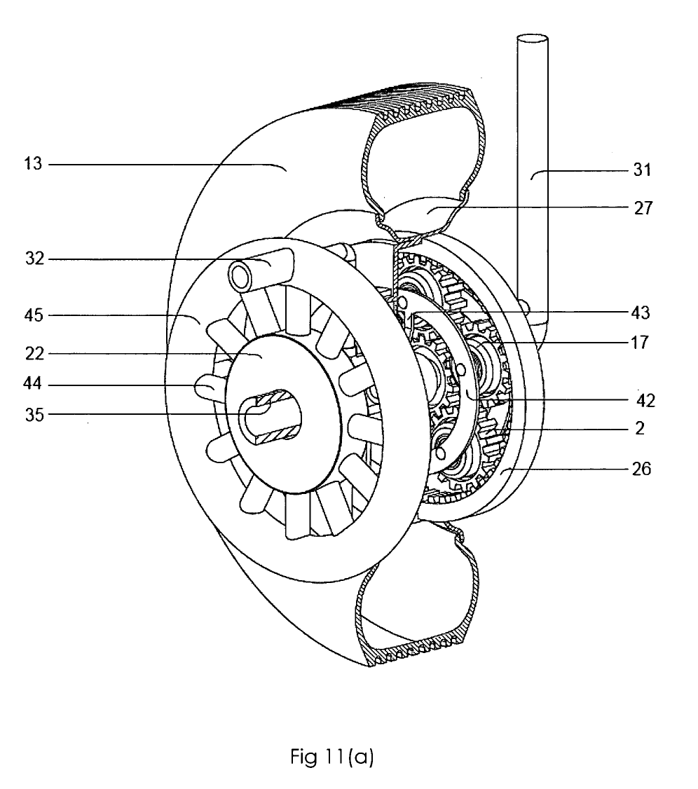

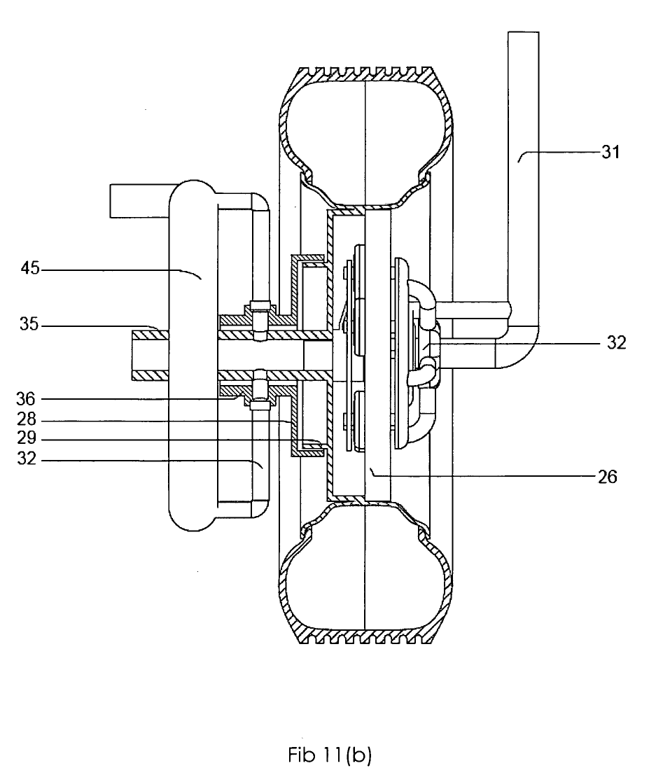

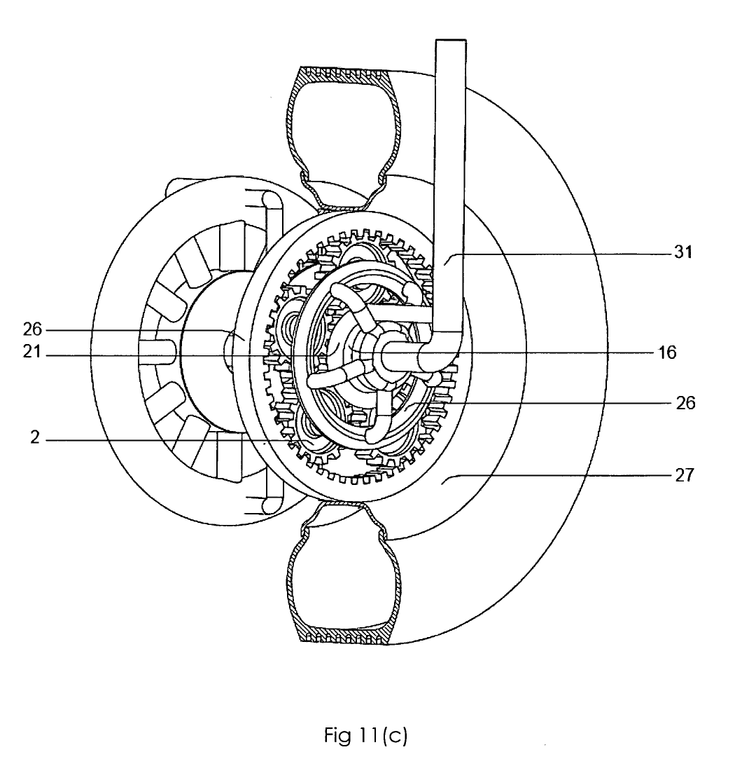

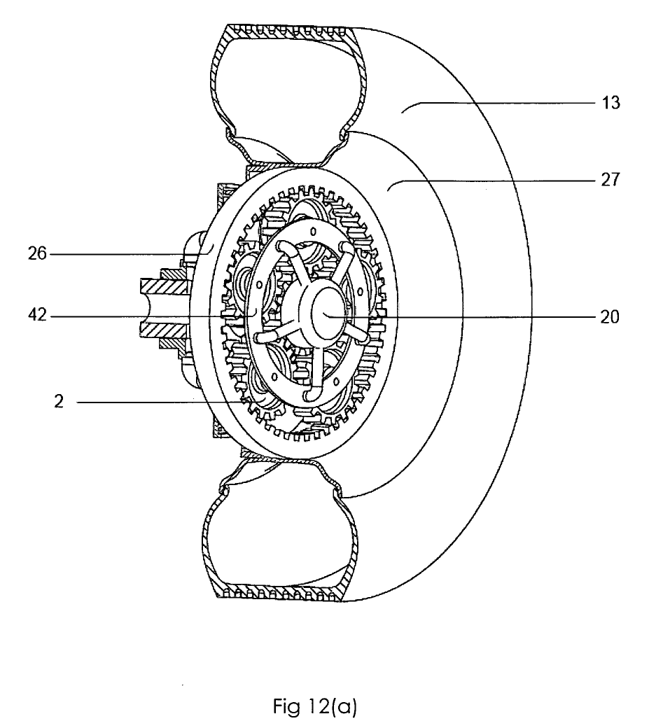

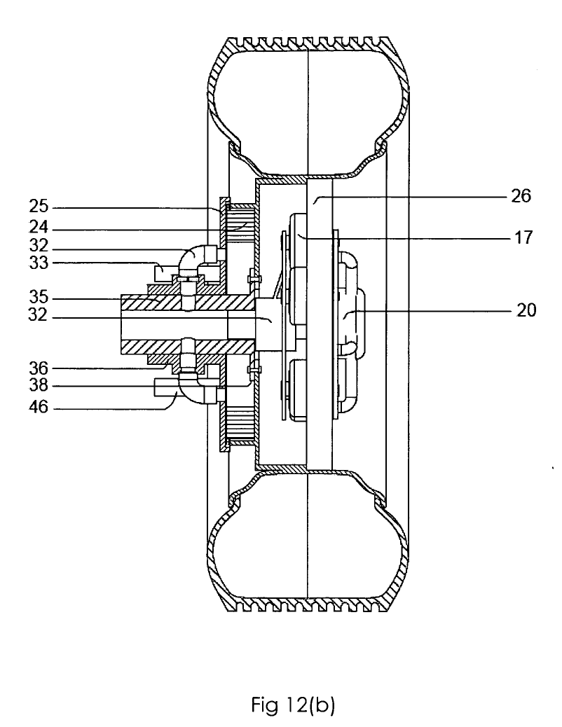

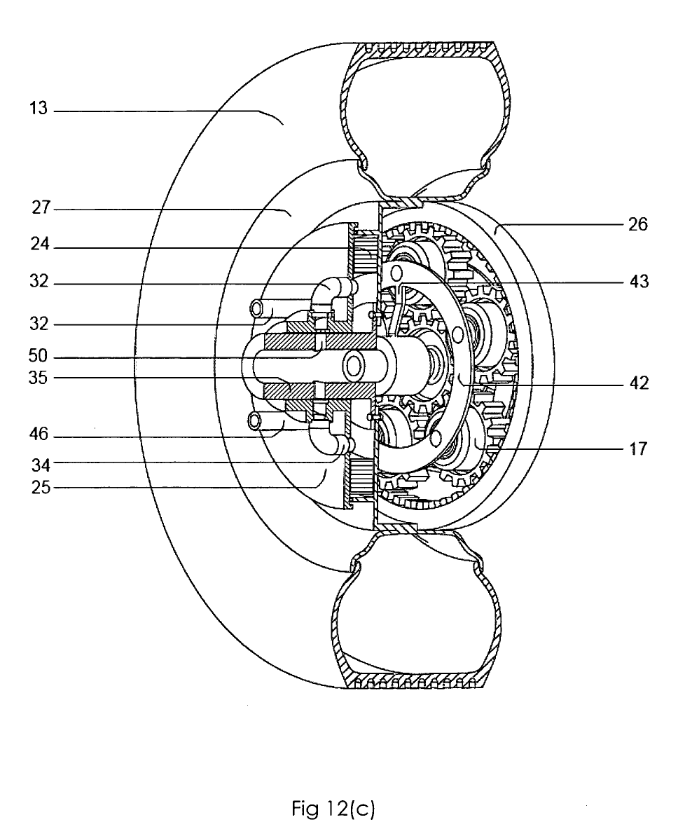

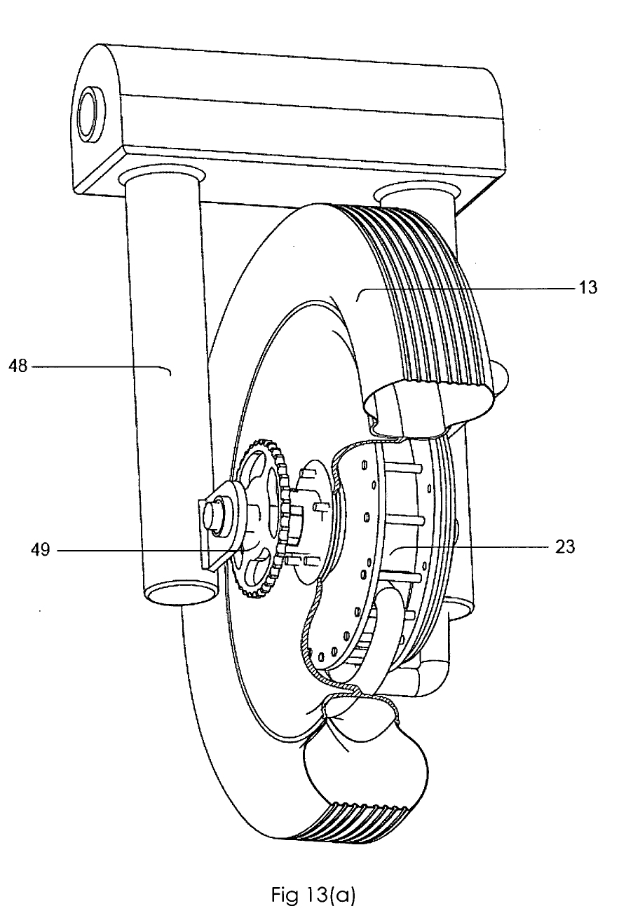

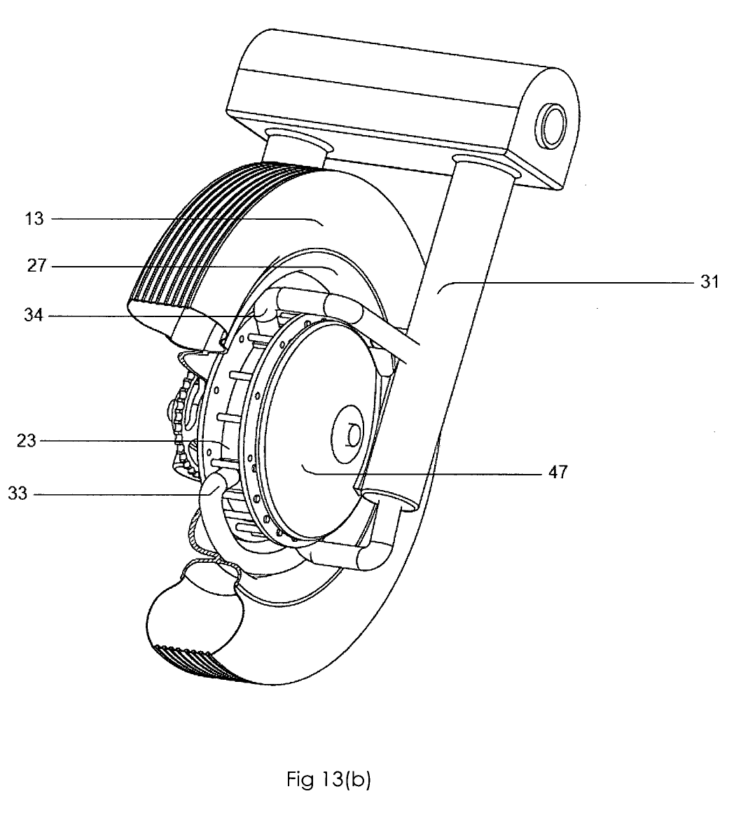

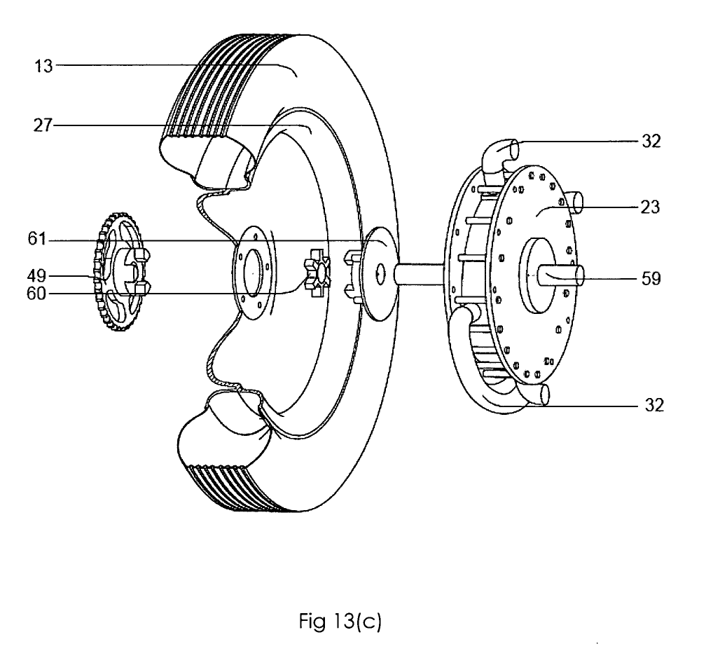

In several places we referred to a multi-tubed or multi-piped fuel cell. A multi-pipe fuel cell consists of three pipes inside each other completely isolated electrically and fluidically (a fluid in one will not leak into another). So, each pipe has its own input and output. Both the inner and outer surfaces of the middle pipe are covered with anode material so as to act as a fuel cell anode (51) while the middle pipe is filled by a sea water (Electrolyte). The inner pipe has both its inner and outer surfaces coated with a cathode material so as to act as a fuel cell cathode (52), while the inner pipe is filled by exhaust gases by being used as an exhaust conduit within the present invention. Oxygen is allowed to flow through the outermost pipe, and thus the multi-pipe apparatus may perform as a fuel cell. At certain stages the exhaust gases and water maybe mixed. Also, this or a similar multi-piped apparatus can be configured to act as an electrolyser within the present invention.

This cell can be assembled in parallel by connecting inputs and outputs of similar pipes together, or serial by connecting pipes directly in a straight line. When we assemble one complete unit; first we insert pipes inside each other separated by a PVC spacer ring (53) at a certain distance, then close the outer pipe by a suitable In/Out extension (54) and put a suitable close nut (56) in the 3 inch inner pipe extension hole with a suitable dropout prevention rubber ring (57), repeat this with the middle pipe but with suitable parts, last one extend the inner pipe and do the same things at the other side.

The elements of the drawings are numbered as follows:

1. Wheel rim and ring gear

2. Planet gear

3. Sun gear and/or sun gear shaft

4. Wheel rim nave/plate and planet gears' carrier

5. secondary planet gear

6. Wheel hub/brake unit

7. Main and/or secondary wheel shaft(s)

8. Area for pump, compressor, alternator, generator, electric motor and/or rotary engine (any of the described devices which either output torque or take in torque as input)

9. King pin

10. Shock absorber

11. Coil spring

12. Leaf spring

13. Tire

14. Wheel nut

15. Compressor wheel

16. Compressor wheel housing

17. Alternator

18. Turbine housing

19. Drum brake

20. Combined pump and compressor

21. Electrolyser

22. Piston rotary engine

23 Quasiturbine rotary engine

24. Quasiturbine rotor

25. Quasiturbine stator

26. Ring gear

27. Wheel rim

28. Backing plate for drum brake

29. Rotor of drum brake

30. Differential

31. Swing arm with exhaust conduit

32. Exhaust conduit

33. Rotary engine exhaust port

34. Rotary engine intake port

35. Wheel axle shaft

36. Wheel axle shaft housing

37. Axle shaft exhaust hole

38. Stub axle/axle stub

39. Alternator stator

40. Alternator rotor

41. Turbine

42. Planet gear carrier

43. Distributor rotor

44. Piston

45. Circular tube exhaust conduit

46. Fuel conduit

47. Support flange

48. Swing arm

49. Sprocket wheel/gear

50. Controllable exhaust passage

51. Anode

52. Cathode

53. PVC Spacer

54. In/Out Extension

55. Inner pipe(s) Extension Hole

56. PVC Close Nut

57. Dropout Prevention Rubber Ring

58. Link Pipe

59. Quasiturbine rotor shaft

60. Rubber part of sleeve coupling

61. Self-center bearing

62. Alternator shaft with hollow center

63. Journal bearing

FIG. 5 is a graph describing the different operating points of a vehicle. On the x-axis is the RPM (revolutions per minute) of a vehicle's engine. The HP curve graphs the horse power in relation to RPM, this curve has a maximum at point A (at point A is when the vehicle reaches maximum horsepower). The T curve graphs the vehicle's engine's torque in relation to RPM, this curve has a maximum at point B (at point B is when the vehicle's engine reaches maximum torque). The S.F.C curve graphs the Specific Fuel Consumption of the vehicle in relation to RPM, this curve has a minimum at point C (at point C is when the vehicle reaches minimum Specific Fuel Consumption). The x-axis (RPM) is divided into three regions I,II and III.I is the region where the vehicle is operation at idle or low load, at this region is when some of the embodiments of the present invention use a rotary and/or electric engine(s) within such an embodiment of the present invention to propel the vehicle rather than using the vehicle's engine. The II region covers the operational points between minimum fuel consumption and maximum torque and is the region where the vehicle's engine is most efficient, and thus the vehicle's engine is used to propel the vehicle in this region. The III region covers the operational points between maximum torque and maximum horse power, it is possible to use the vehicle's engine with a lean fuel mixture to increase the efficiency of the vehicle's engine at this region. The operation of an engine beyond the limits of these regions (the operation of the engine in the region to the right of region III) is undesirable because it is accompanied by a simultaneous reduction of power and deterioration of engine fuel economy.

FIG. 6 graphs the tractive force/tractive effort and the total resistance for the vehicle in relation to the vehicle's wheels' RPM where the x-axis represents the vehicle's wheels' RPM and the y-axis represents force. The T.E. curve graphs the tractive force/tractive effort in relation to the vehicle's wheels' RPM. The T.R. curve graphs the total resistance force to the vehicle in relation to the vehicle's wheels' RPM. This curve shows that at most RPMs bellow the RPM at point M.S. (maximum speed) there is a surplus of tractive force (as detailed in earlier in the description), for example at the RPM of point A we have S surplus tractive force.

FIG. 7 graphs the vehicle's speed (V) on the y-axis in relation to time (x-axis) in order to illustrate the behavior during braking, inertial motion, uniform motion and acceleration of the vehicle. The vehicle is accelerating in the region between points A and B, where the steps are gear shifts in the vehicle's transmission; in this region a rotary engine within some embodiments of the present invention that is a Quasiturbine engine can be used as described. The vehicle is in uniform motion in the region between points B and C (constant speed); in this region the vehicle's engine is used. The vehicle is in motion due to it's inertia (coasting) in the region between points C and D, and finally the vehicle is braking in the region between points D and E; for the region between points C and E a rotary and/or electric engine within some embodiments of the present invention can also be used.

FIGS. 8a, 8b, 8c, 9, 11a, 11b, 11c, 12a, 12b, 12c, 13a, 13b and 13c are figures of specific

FIG. 10 is a flow chart illustrating a very basic functionality of the present invention.

### BEST MODE

Generally the specific embodiment of this invention depends on among many other things the vehicle that will use it, the wheel and wheel rim type and size, the size and type of the brake within the wheel rim (if there is one), the type of suspension system on that wheel rim, local environmental policy, local technology policy and the vehicle owner's preferences. Due to this, there is no single best mode, however here are some specific and useful embodiments of the present invention.

One possible embodiment of the present invention (FIGS. 8a, 8b, and 8c) is arranged as follows. On one side of the wheel rim is a planetary gear mechanism where the wheel rim (27) acts as the ring gear (26) by having gear teeth along its inner surface. The sun gear in this planetary gear mechanism drives a (15) compressor wheel.

For each of the planet gears (2) on this planetary gear mechanism there is a corresponding alternator (17), each of these planet gears is connected to a stator (39) of one of these alternators (where each alternator is connected to a unique planet gear) so as to rotate the stator of this alternator when the planet is in motion. In each of these alternators the stator and rotor (40) have a journal bearing between them so they can move freely with respect to one another. Each of the rotors accompanying the stators is driven (in the direction opposite to that of the rotor's respective stator) by a distinct turbine (41) connected to the given rotor with a shaft, where this turbine is surrounded by a housing (18).

Beside the wheel rim is a swing arm (31) which contains an exhaust conduit connected to the vehicle's exhaust system. This exhaust conduit (which is connected to the vehicle's exhaust system) meets the compressor wheel (15) so that as the wheel is rotated a pumping and compression action is being performed on the exhaust gases via this compressor wheel (15) which pumps and compresses the exhaust gases into a compressor wheel housing (16) surrounding this compressor wheel. The housing of the compressor wheel is connected to each of the turbine housings (18) so that exhaust gases may flow from the compressor wheel housing into these turbine housings. As exhaust gases flow from the compressor wheel housing and into the turbine housings the turbines in will be rotated, and will thus drive the rotors of their respective alternators. An arm is also extended from the swing arm to the planet gear carries in order to hold the planet gear carrier (42) static with respect to the rotation of the wheel.

On the side of the wheel rim opposite the planetary gear mechanism there is a drum brake which has a free centre, within the free centre is a quasiturbine rotary engine (23) which also has a free centre. This quasiturbine rotary engine has it's stator (25) held static by having it connected to a static plate within the brake (28) and has its rotor connected to a rotating plate within the brake (where the brake is acting as the aforementioned drive mechanism), thus as the wheel rim rotates and rotates this rotating plate within the brake, this rotating plate (29) within the brake rotates the rotor of the quasiturbine rotary engine (23).

The aforementioned shafts which connect the aforementioned turbines to their respective alternator rotor have a hollow centre allowing exhaust gases from the turbine housing to flow through them to the other side of the planetary gear mechanism. On that side of the planetary gear mechanism these shafts are met with exhaust conduits (32) all converging to the wheel's axle shaft (35). The wheel's axle shaft also having a free centre allows the exhaust gases to flow through it, where they are then allowed to flow into the axle shaft housing (36) and from the axle shaft housing through exhaust conduits (32) and into the intake ports of the quasiturbine rotary engine (23). The quasiturbine also has its exhaust port (33) fluidically connected to a gas storage unit.

In this embodiment, when the wheel is rotating the sun gear is being driven, as a result the compressor wheel (driven by the sun gear) pumps the exhaust gases from the exhaust system through the exhaust conduit connected to the swing arm and compresses them into the compressor wheel housing. From the compressor wheel housing the pumping action pushes the exhaust gases into the turbine wheel housings, through the turbine shafts and into the conduits leading to the quasiturbine rotary engine. As the wheel rim rotates, the rotor of the quasiturbine is rotated by the rotating plate of the brake—thus as the wheel rim rotates, the quasiturbine pumps and further compresses the exhaust gases out of the quasiturbine's exhaust outlet through an exhaust conduit connected to this outlet and into the gas storage unit.

In this arrangement, as the wheel is rotated and it acts to rotate/drive both the planetary gear mechanism and the rotary engine's rotor (24). The planet gears (2) then act to rotate/drive the stators (39) to which they are connected and produce electricity. The exhaust gases will first be pumped towards the compressor wheel (15) and compressed into the compressor wheel housing (16), the exhaust gases then flow from the compressor wheel housing to the turbine wheel housings (18) on each planet gear and the thermal energy from the exhaust gas is used to turn the rotors of the alternators in a direction opposite to the rotation of the stators (thus using the exhaust heat to create more electricity). The exhaust gases are then pumped from the turbine housings (18) into the quasiturbine rotary engine (23) and further compressed into the gas storage unit by the quasiturbine rotary engine.

In this embodiment, the electrical energy produced by the alternators can be transferred through a circuit running alongside the exhaust conduits and through the wheel axle shaft (35).

There is an important advantage in having the compressor wheel pump and compress the exhaust gases and then having the quasiturbine rotary engine do the same. The compressor wheel can have an intake pipe with a diameter as large as that the exhaust line pipe's diameter where the rotary engine has a significantly smaller input; in this arrangement the compressor wheel may compress the exhaust gases before they reach the rotary engine which can then serve to compress them further, thus possibly increasing both the rate at which the exhaust gases are pumped and compressed as well as the compression ratio.

Another possible embodiment of the present invention (FIGS. 12a, 12b and 12c) is designed to be used within vehicles using a piston engine.

On one side of the wheel rim is a planetary gear mechanism where the ring gear (26) is connected to the wheel rim (27) so that as the wheel rim is rotating, it rotates/drives the ring gear (26) of this planetary gear mechanism. The sun gear (3) in this planetary gear mechanism drives a combined pump and compressor (20) through a shaft with a hollow centre. For each of the planet gears (2) on this planetary gear mechanism there is a corresponding alternator (17), each of these planet gears is connected to a stator (39) of one of these alternators (where each alternator is connected to a unique planet gear) so as to rotate/drive the stator of this alternator when the vehicle is in motion. In each of these alternators the stator and rotor (40) have a journal bearing between them so they can move freely with respect to one another. The rotor of each alternator is fixed to the shaft going through the given planet gear, this shaft being fixed to the planet gear carrier (42). As a result, when the wheel rim is rotating, the planet gear rotates the stator about a static rotor to generate electricity.

Some of the electricity generated by the group of alternators is provided to other parts of the vehicle. The alternator shafts are all connected to a planet gear carrier (42) on the side of the planetary gear mechanism nearest the axle shaft (35). The electricity from each alternator (17) is conducted by a section of this planet gear carrier. An arm capable of conducting electricity (43) and which is rotated by the wheel axle shaft (35) is always in contact with this planet gear carrier (42)—in the same manner that a distributor rotor works within a distributor (a device well known in the art)—we shall refer to this arm as a distributor rotor. This distributor rotor and a series of wires connected to it which go through the wheel axle shaft conduct electricity generated by the alternators into the rest of the vehicle.

On the side of the wheel rim opposite the pump and compressor is a Quasiturbine rotary engine (23) where an elliptical cavity in the wheel rim acts as the stator (25) for this engine and where the rotor is held static by a static plate connected to the axle shaft housing (36) for that wheel. Thus as the wheel rim is rotating, the stator of the quasiturbine rotates around the rotor, creating an equivalent effect as would result from moving the rotor within a static stator.

Beside the wheel rim is a swing arm which contains an exhaust conduit (31) connected to the vehicle's exhaust system—this swing arm is not shown in figures for this embodiment, but it is similar to that in FIG. 8a. The planet gear carrier (42) is rigidly connected to this swing arm so as to be held static with respect to the rotation of the wheel rim. This exhaust conduit (which is connected to the vehicle's exhaust system) meets the combined pump and compressor (20) so that as the wheel is rotated, the sun gear (3) is driven, which thus drives the combined pump and compressor and a pumping and compression action is thus performed on the exhaust gases. The shaft driving the combined pump and compressor is then used as a conduit for the exhaust gases—routing them to the other side of the planetary gear mechanism. From there the exhaust gases are pumped through the axle shaft (35). Between the axle shaft and the axle shaft housing there is a controllable exhaust passage (50). When this passage is closed, the exhaust gases go directly from the axle shaft and into a gas storage unit. When this passage is open the exhaust gases flow through the axle shaft, into the axle shaft housing, then through a conduit and into the quasiturbine intake ports (34)—these exhausts are then reburned by that quasiturbine and pushed out of the quasiturbine's exhaust port (33) and into the gas storage unit.

As mentioned in the Background Art, a piston engine will be very fuel inefficient at lower speeds and at maximum speeds, therefore this Quasiturbine rotary engine is used to drive the vehicle at speeds where it is more fuel efficient than the piston engine and the piston engine is used to drive the vehicle at speeds where it is more fuel efficient than the Quasiturbine rotary engine. This of course will significantly improve the fuel efficiency of the vehicle. Furthermore, this Quasiturbine rotary engine can be used to reburn the captured exhaust gases (which still have an amount of unburned fuel) or reburn exhaust gases that have been enriched with a fuel mixture at select speeds (for example, when the vehicle is at a drive-through restaurant).

Another possible embodiment of the present invention, a part of which is shown in (FIG. 11a, 11b, 11c), to be used within a vehicle having a wheel rim.

On the side of the wheel rim is a planetary gear mechanism having it's ring gear (26) connected to the wheel rim so as to be rotated by the wheel rim when the wheel rim is rotating. The sun gear (3) of this planetary gear mechanism drives a compressor wheel (15) with a shaft having a hollow centre and a multi-tube structure within it (multiple tubes within each other, so if there were 3 tubes for example, we would have a larger outside tube, within it would be the second tube and within the second tube would be the third).

Beside the wheel rim is a swing arm (31) which contains an exhaust conduit connected to the vehicle's exhaust system. An arm is also extended from the swing arm to the planet gear carrier (42) in order to hold the planet gear carrier static with respect to the rotation of the wheel. This exhaust conduit (which is connected to the vehicle's exhaust system) meets the compressor wheel so that as the wheel is rotated a pumping and compression action is being performed on the exhaust gases via this compressor wheel which pumps and compresses the exhaust gases into a compressor wheel housing (16) surrounding this compressor wheel.

The compressor wheel housing, which is conventionally a ring tube structure has another ring tube structure around it which is an electrolyser (21) that has water flowing pumped into it from conduit in the swing arm. This electrolyser breaks down the water into hydrogen gas and oxygen gas, the hydrogen gas is allowed to flow through into the compressor wheel housing (16) where it mixes with the captured exhaust gases while the oxygen gas is allowed to flow through to a separate section of the compressor wheel housing. This electrolyser has water pumped into it by a pump within the vehicle where this water is heated by the vehicle engine's cooling system before it is used within the electrolyser so as to reduce the activation energy necessary for electrolysis.

The hydrogen enriched exhaust gases in the compressor wheel housing (16) are pumped from the compressor wheel housing through one of the tubes in the shaft with a hollow centre which is connected to the compressor wheel (15) and to the other side of the planetary gear mechanism. The exhaust gases are then pumped through the axle shaft (35), into the axle shaft housing (36). Here the axle shaft also has a multitube structure within it, allowing the passage of different fluids/gases. The oxygen generated by the electrolyser (21) residing in the compressor wheel housing is pumped into a different tube within the axle shaft in the same way—however it is also being pumped through a different tube within the shaft with a hollow centre connecting the compressor wheel to the sun gear.

For each of the planet gears (2) on this planetary gear mechanism there is a corresponding alternator (17), each of these planet gears is connected to a stator (39) of one of these alternators (where each alternator is connected to a unique planet gear) so as to rotate the stator of this alternator when the vehicle is in motion. In each of these alternators the stator and rotor (40) have a journal bearing between them so they can move freely with respect to one another. The rotor of this alternator is fixed to the shaft going through the given planet gear, this shaft being fixed to the planet gear carrier (42). As a result, when the wheel rim is rotating, the planet gear rotates the stator about a static rotor to generate electricity. The electricity provided by these alternators is used to power the electrolyser in the compressor wheel housing and can also be used by any combination of the other devices detailed earlier.

Some of the electricity generated by the group of alternators is provided to other parts of the vehicle. The alternator shafts are all connected to a planet gear carrier (42) on the side of the planetary gear mechanism nearest the axle shaft (35). The electricity from each alternator (17) is conducted by a section of this planet gear carrier. An arm capable of conducting electricity (43) and which is rotated by the wheel axle shaft (35) is always in contact with this planet gear carrier (42)—in the same manner that a distributor rotor works within a distributor (a device well known in the art)—we shall refer to this arm as a distributor rotor. This distributor rotor and a series of wires connected to it which go through the wheel axle shaft conduct electricity generated by the alternators into the rest of the vehicle.

This embodiment further comprises a piston rotary engine (22) positioned on the wheel axle shaft (35) connected to the wheel rim, this wheel axle shaft being controllably coupled to the crankshaft of the piston rotary engine so that when the coupling is activated, as the crankshaft rotates the wheel rim also rotates, and if the wheel rim rotates the crankshaft of the piston rotary engine also rotates. This piston rotary engine is of a small size similar to model piston rotary engines used in model boats and model airplanes. This piston rotary engine has 10 cylinders and is configured to run with 4 independent circuits.

This piston engine is surrounded by a circular tube structure (45) with at least 2 compartments capable of holding both exhaust gases and oxygen gas separately—this circular tube structure has a conduit connecting it to the axle shaft housing (36) such that both the hydrogen enriched exhaust gases and the oxygen are pumped into different sections of this circular tube structure.

The first circuit consisting of 2 unique pistons with deactivated spark plugs is connected to section of the circular tube structure having the hydrogen enriched captured exhaust gases such that these hydrogen enriched exhaust gases are input for these pistons. As the crankshaft of this piston rotary engine rotates (either as a result of the wheel rim itself being in motion or as a result of a torque generated by the piston rotary engine itself) the pistons in this piston rotary engine also rotate and thus the pistons of the first circuit act to pump and compress these enriched exhaust gases out of the exhaust outlet and into a gas storage unit.

The second circuit of this piston rotary engine also consists of 2 unique pistons with deactivated spark plugs is connected to section of the circular tube structure having the oxygen such that this oxygen gas is input for these pistons.. Thus as the crankshaft of this piston rotary engine rotates, the pistons of the second circuit act to pump and compress this oxygen out of the exhaust outlet of these pistons, through an exhaust conduit in the vehicle and into the vehicle' internal combustion engine (not shown). This compressed oxygen can be used to increase the volumetric efficiency of the vehicle's engine in the same way as the air compressed by a turbocharger (and also reduce the amount of NOx produced by the vehicle's vehicle's engine's combustion process).

The third circuit of this piston rotary engine consists of 4 unique pistons, which have their fuel input connected to the gas storage unit which stores the hydrogen enriched exhaust gases. This circuit can be used on demand for minor propulsion of the vehicle by reburning the hydrogen enriched exhaust gases. The fourth circuit consists of two unique pistons which have their output connected to another gas storage unit and their input connected the exhaust valve ports/outlets of the 4 pistons of the third circuit, so that as the third circuit is used as propulsion by reburning the enriched exhaust gases, the fourth circuit's pistons are used to pump and compress the reburned exhaust gases of the third circuit into another gas storage unit.

Another embodiment of the present invention (as shown in FIG. 13a, 13b, 13c) can be used on a motorcycle wheel. This motorcycle wheel is driven by a sprocket wheel/gear (49). On one side of the wheel there is a quasiturbine rotary engine (23) with the stator being held static by a support flange (47). This support flange is fixed to a swing arm which has an exhaust conduit (31). The intake ports (34) and the exhaust ports (33) of the quasiturbine have an exhaust conduit (32) connecting them to the swing arm (31).

The quasiturbine rotary engine's rotor is driven by the quasiturbine rotor shaft (59) which is driven by the wheel. As the wheel is rotating, the quasiturbine's rotor is driven, thus exhaust gases are pumped into the intake port of the quasiturbine, compressed and pumped out of the exhaust port of the quasitrubine and back through a conduit within the swing arm to a gas storage unit.

### INDUSTRIAL APPLICABILITY

The present invention can be both incorporated into new vehicle designs and vehicles that are already on the road. The invention will also have a market in the electrical energy production industry and in the development of a new electric economy. Since the main function of the present invention is to capture and store a vehicle's exhaust gases, the captured exhaust gases can be measured and can be used to generate carbon credits which can be exchanged in a carbon market, as such the present invention also creates a demand for a financial product with a financial rate of return. Also, since some important embodiments of the present invention use fuel cells, the present invention can create demand for fuel cells, and since some important embodiments of the present invention generate and/or use hydrogen, the present invention can be used as part of a gateway for a hydrogen economy.

The present invention can also have vast economic benefits in today's jobless and weak economy by providing highly labour-intensive manufacturing jobs for building smaller devices. For example, the fuel cells that can be incorporated within some embodiments of the present invention can be built easily without necessitating the extreme precision needed in building parts such as pistons in an engine, since an engine loses fuel and energy efficiencies as the pistons wear. All of this is done while helping the environment, such a technology which can have both immediate economic rewards as well as immediate and long term environmental benefits are rare and highly needed.

1. An apparatus for use with a wheeled vehicle, wherein the vehicle comprises an internal combustion engine having an exhaust manifold for directing away exhaust gases produced by the engine, wherein the vehicle comprises at least one wheel disposed for supporting or propelling the vehicle, and wherein the apparatus comprises:
at least one compressive device and at least one exhaust gas storage unit, wherein the compressive device is fluidically connected to receive at least a portion of the exhaust gases from the engine or from the exhaust manifold, and to direct the gases toward the at least one storage unit; and wherein the at least one compressive device is operatively connected to the at least one wheel by at least one drive mechanism such that operation of the at least one compressive device compresses the portion of the exhaust gases into the at least one storage unit.

2. The apparatus of claim 1, wherein the at least one compressive device is adapted and arranged for pumping the exhaust gases.

3. The apparatus of claim 1, wherein the at least one compressive device is one or more from the group comprising Quasiturbine rotary engines, turbines, fluid pumps, compressor wheels, rotary engines, Wankel rotary engines, piston rotary engines and Brayton rotary engines.

4. The apparatus of claim 1, wherein the at least one drive mechanism is one or more from the group comprising rack and pinion geared apparatus, a geared wheel hub driving a geared axle connected to the at least one compressive device, a wheel shaft for the at least one wheel such that energy from the one or more components of the vehicle is provided to the compressive device to compress the exhaust gases into the at least one gas storage unit, and at least one planetary gear mechanism operatively connected to the at least one wheel.

5. The apparatus of claim 1, wherein the fluidic connection between the compressive device and the exhaust apparatus comprises valve means adapted and arranged for directing the gases from the engine to the compressive device.

6. The apparatus of claim 1, wherein the fluidic connection between the compressive device and the at least one storage unit comprises valve means adapted and arranged for reversibly storing the gases in the at least one gas storage unit.

7. The apparatus of claim 1, wherein the at least one gas storage unit is fluidically connected downstream from the at least one compressive device.

8. The apparatus of claim 1, further comprising at least one transducer, wherein the at least one transducer is operatively connected to the apparatus such that energy created or gathered by the vehicle or by the apparatus can be stored or transduced.

9. The apparatus of claim 8, wherein the at least one transducer is operatively connected to one or more of the at least one drive mechanism, the at least one gases storage unit, the vehicle and the exhaust manifold.

10. The apparatus of claim 8, wherein the at least one transducer comprises one or more generators for generating electricity operatively connected to the at least one drive mechanism.

11. The apparatus of claim 1, wherein the at least one compressive device comprises at least one rotary engine that is configured for pumping and compressing the exhaust gases.

12. The apparatus of claim 8, wherein the at least one transducer is selected from the group comprising electrical generators, electrical alternators, rotary engines, electrical power inverters and turbines.

13. The apparatus of claim 12, further comprising an air/fuel inlet adapted and arranged for introducing into the at least one rotary engine one or more of the exhaust gases from said internal combustion engine, combustion air from the outside atmosphere and one or more fuels from the vehicle fuel storage containment to form an auxilliary combustible mixture, wherein the at least one rotary engine is adapted and arranged to function interchangeably as one or more of a pump, a compressor, and a propulsion device.

14. The apparatus of claim 11, wherein the at least one rotary engine is one or more selected from the group comprising Wankel rotary engines, Brayton rotary engines, Quasiturbine rotary engines, and piston rotary engines.

15. The apparatus of claim 1, wherein the one or more exhaust gases storage units are adapted and arranged to be disposed within one or more portions of the at least one wheel.

16. The apparatus of claim 15, wherein the one or more portions of the at least one wheel are selected from the portions comprising the internal or external portions of the wheel rim and the internal or external portions of the wheel hub.

17. The apparatus of claim 1, wherein one or more portions of the at least one wheel selected from the portions comprising the internal or external portions of the wheel rim and the internal or external portions of the wheel hub are used to store a fuel mixture for one or more of the vehicle's internal combustion engine and a rotary engine.

18. The apparatus of claim 1, wherein the at least one drive mechanism comprises at least one planetary gear mechanism operatively connected to the at least one wheel, and wherein the at least one wheel of the vehicle comprises a rim, the rim having an inner surface and an outer surface, the rim further comprising an inner circular rim circumference, the inner rim circumference being adapted and arranged to accept a ring gear adapted and arranged on or adjacent the rim circumference such that the rim can operatively communicate with the planetary gear mechanism, and wherein the at least one planetary gear mechanism comprises a sun gear, a plurality of planet gears, a planetary gear carrier, and a ring gear, wherein the ring gear is adapted and arranged on or adjacent the rim of the at least one wheel.

19. The apparatus of claim 18, wherein the at least one planetary gear mechanism is operatively connected to a brake mechanism operatively connected to the at least one wheel, the brake mechanism comprising a toothed gear, wherein one of the gears in the at least one planetary gear mechanism is adapted and arranged to engage the toothed gear of the brake mechanism.

20. The apparatus of claim 9, further comprising at least one means for producing hydrogen, wherein the apparatus is adapted and arranged to deliver the hydrogen to one or more of the internal combustion engine and the one or more transducers.

21. The apparatus of claim 20, wherein the means for producing hydrogen is adapted and arranged to be powered by one or more of the transducers.

22. The apparatus of claim 13, further comprising one or more generators for generating electricity, wherein the one or more rotary engines are adapted and arranged to burn the auxilliary combustible mixture and to drive the one or more generators to produce electricity.

23. The apparatus of claim 13, wherein the one or more rotary engines are adapted and arranged to effect the compression and storage of the exhaust gases in the one or more storage units.

24. The apparatus of claim 13, wherein the internal combustion engine is adapted and arranged to burn fuel comprising the auxilliary combustible mixture, and wherein the device for enriching the combustion engine fuel/air mixture is at least partially powered by the one or more generators.

25. The apparatus of claim 13, further comprising a device for enriching the auxiliary combustible mixture with an enriching fuel mixture.

26. The apparatus of claim 13, further comprising a hydrogen generator adapted and arranged for producing hydrogen, wherein the hydrogen is providable to comprise the auxilliary combustible mixture.

27. The apparatus of claim 1, further comprising an auxiliary motor adapted and arranged to drive at least one compressive device corresponding to the auxiliary motor, wherein the at least one compressive device corresponding to the auxiliary motor is adapted and arranged to capture and compress the exhaust gases into the at least one gas storage unit.

28. The apparatus of claim 1, further comprising an auxiliary motor adapted and arranged to drive the at least one compressive device, wherein the at least one compressive device is adapted and arranged to capture and compress the exhaust gases into the at least one gas storage unit.

29. The apparatus of claim 26, wherein one or more aqueous fluids are provided to the hydrogen generator, and the apparatus is adapted and arranged such that the fluids are preheated by heat from one or more of the internal combustion engine, the exhaust manifold, the exhaust gases, the muffler and the drive mechanisms.

30. The apparatus of claim 1, further comprising at least one fuel cell for generating electricity, wherein the at least one fuel cell is adapted and arranged to use the exhaust gases as fuel.

31. The apparatus of claim 1, further including a generator for generating electricity, wherein the generator is adapted and arranged to converts some of the thermal energy of the exhaust gases into electrical energy.

32. The apparatus of claim 1, further comprising at least one thermal energy transfer means adapted and arranged for transferring a portion of the heat produced by one or more of the internal combustion engine and the exhaust gases into electrical energy.

33. An apparatus for use with a wheeled vehicle, wherein the vehicle comprises an internal combustion engine having an exhaust manifold for directing away exhaust gases produced by the engine, wherein the vehicle comprises at least one wheel disposed for supporting or propelling the vehicle, the at least one wheel having a wheel axle operatively connected thereto, and wherein the apparatus comprises:
at least one compressive device and at least one exhaust gas storage unit, wherein the compressive device is fluidically connected to receive at least a portion of the exhaust gases from the engine or from the exhaust manifold, and to direct the gases toward the at least one storage unit; and wherein the at least one compressive device is operatively connected to the wheel axle of the at least one wheel by at least one drive mechanism such that operation of the at least one compressive device compresses the portion of the exhaust gases into the at least one storage unit.
